(19) United States
(12) Patent Application Publication
(10) Pub. No.: US 2023/0362231 A1
(43) Pub. Date: Nov. 9, 2023

(54) OPTIMIZING DATA STORAGE ACROSS MULTIPLE CONTENT REPOSITORIES

(71) Applicant: Citrix Systems, Inc., Fort Lauderdale, FL (US)

(72) Inventors: Amogh Madanayakanahalli Kumar, Davanagere (IN); Praveen Raja Dhanabalan, Nagercoil (IN); Shubham Choudhary, Bengaluru (IN)

(21) Appl. No.: 17/841,135

(22) Filed: Jun. 15, 2022

(30) Foreign Application Priority Data
May 4, 2022 (IN) 202211025943

(51) Int. Cl. H04L 67/06; H04L 67/1097; H04L 67/52; H04L 67/63

(52) U.S. Cl. CPC H04L 67/06; H04L 67/1097; H04L 67/52; H04L 67/63

(57) ABSTRACT

In one disclosed embodiment, a computing system may instruct a first content repository to store a first part of a file but not a second part of the file, the first content repository being associated with a first internet protocol (IP) address, and may instruct a second content repository to store the second part of the file but not the first part of the file, the second content repository being associated with a second IP address that is different than the first IP address. In response to the computing system receiving a request for the file from a client device, the computing system may instruct the client device to retrieve the second part of the file, but not the first part of the file, from the second content repository using the second IP address.

### CROSS-REFERENCE TO RELATED APPLICATIONS

This application claims priority under 35 U.S.C. § 119(a) to Provisional Application No. 202211025943, entitled OPTIMIZING DATA STORAGE ACROSS MULTIPLE CONTENT REPOSITORIES, which was filed with the Indian Patent Office on May 4, 2022, the entire contents of which are incorporated herein by reference for all purposes.

### BACKGROUND

Various file sharing systems have been developed that allow users to share files or other data. ShareFile®, offered by Citrix Systems, Inc., of Fort Lauderdale, FL, is one example of such a file sharing system.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method comprises instructing, by a computing system, a first content repository to store a first part of a file but not a second part of the file, the first content repository being associated with a first internet protocol (IP) address; instructing, by the computing system, a second content repository to store the second part of the file but not the first part of the file, the second content repository being associated with a second IP address that is different than the first IP address; and in response to the computing system receiving a first request for the file from a first client device, instructing, by the computing system, the first client device to retrieve the second part of the file, but not the first part of the file, from the second content repository using the second IP address.

In some embodiments, a method comprises determining, by a computing system, a first predicted bandwidth between a first client device located in a first region and a first content repository located in the first region, the first content repository being associated with a first internet protocol (IP address); determining, by the computing system, a second predicted bandwidth between the first client device located in the first region and a second content repository located in a second region, the second content repository being associated with a second IP address; determining, by the computing system, a first ratio of the first predicted bandwidth and the second predicted bandwidth; determining that a file is to be stored by a combination of the first content repository and the second content repository; determining, by the computing system and based at least in part on the first ratio, a first part of a file that is to be stored by the first content repository and a second part of the file that is to be stored by the second content repository; instructing, by the computing system, the first content repository to store the first part of the file but not the second part of the file; and instructing, by the computing system, the second content repository to store the second part of the file but not the first part of the file.

In some embodiments, a computing system comprises at least one processor, and at least one computer-readable medium encoded with instructions which, when executed by the at least one processor, cause the computing system to instruct a first content repository to store a first part of a file but not a second part of the file, the first content repository being associated with a first internet protocol (IP) address, to instruct a second content repository to store the second part of the file but not the first part of the file, the second content repository being associated with a second IP address that is different than the first IP address, and to instruct, in response to receipt of a first request for the file from a first client device, the first client device to retrieve the second part of the file, but not the first part of the file, from the second content repository using the second IP address.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is a high-level diagram illustrating a first example of a how a computing system may orchestrate optimized distributed storage of a file by multiple content repositories, in accordance with some embodiments of the present disclosure;

FIG. 1B is a high-level diagram illustrating a second example of how a computing system may orchestrate optimized distributed storage of a file by multiple content repositories, in accordance with some embodiments of the present disclosure;

FIG. 2 is a diagram of a network environment in which some embodiments of the present disclosure may be deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a diagram illustrating how a network computing environment like one shown in FIG. 2 may be configured to allow clients access to an example embodiment of a file sharing system;

FIG. 5B is a diagram illustrating certain operations that may be performed by the file sharing system shown in FIG. 5A in accordance with some embodiments;

FIG. 5C is a diagram illustrating additional operations that may be performed by the file sharing system shown in FIG. 5A in accordance with some embodiments;

FIG. 6A is a diagram illustrating an example scenario of a networked environment, in accordance with some embodiments;

FIG. 6B is a diagram illustrating an example scenario of a networked environment, in accordance with some embodiments;

FIG. 7A illustrates an upload of a file as part of an example process for optimized distributed storage, in accordance with some embodiments;

FIG. 7B illustrates network speed and connectivity analysis as part of an example process for optimized distributed storage, in accordance with some embodiments;

FIG. 7C illustrates file partitioning as part of an example process for optimized distributed storage, in accordance with some embodiments;

FIG. 7D illustrates generating a portion mapping file as part of an example process for optimized distributed storage, in accordance with some embodiments;

FIG. 8A illustrates a first portion of a first example process for a file download with optimized distributed storage from multiple content repositories, in accordance with some embodiments;

FIG. 8B illustrates a second portion of the first example process partially depicted in FIG. 8A;

FIG. 9A illustrates a first portion of a second example process for a file download with optimized distributed storage from multiple content repositories, in accordance with some embodiments; and

FIG. 9B illustrates a second portion of the second example process partially depicted in FIG. 9A.

### DETAILED DESCRIPTION

For purposes of reading the description of the various embodiments below, the following descriptions of the sections of the specification and their respective contents may be helpful:
Section A provides an introduction to example embodiments of a system for optimizing data storage across multiple content repositories;
Section B describes a network environment which may be useful for practicing embodiments described herein;
Section C describes a computing system which may be useful for practicing embodiments described herein;
Section D describes embodiments of systems and methods for delivering shared resources using a cloud computing environment;
Section E describes example embodiments of systems for providing file sharing over networks;
Section F provides a more detailed description of example embodiments of the system introduced in Section A; and
Section G describes example implementations of methods, systems/devices, and computer-readable media in accordance with the present disclosure.

### A. Introduction to Illustrative Embodiments of a System for Optimizing Data Storage Across Multiple Content Repositories

Data files in a networked environment are commonly stored at data centers. Such data centers may serve a geographically diverse, and possibly global, group of end-users. To better serve such end-users, a file storage service (e.g., ShareFile®) may establish content repositories at multiple points-of-presence (PoP) on the internet, typically at different locations around the globe. A PoP may include servers, routers, and other networking devices established to provide an access point to the internet. By storing the same data file within multiple content repositories at different PoPs, an end-user in need of the file can be directed to the PoP that is best situated to deliver the file to that end-user in a timely manner. For instance, when a client device in the same geographic region as one of the content repositories (e.g., a North American data center) provides a uniform resource locator (URL) identifying a file storage service (e.g., ShareFile®) to the Domain Name System (DNS), that client device may be directed, either directly via one or more DNS servers or indirectly via a primary server of the file storage service, to the internet protocol (IP) address of the content repository that is located in that same geographic region. Downloading the file from a geographically proximate content repository can result in a significantly faster download speed, and thus improve the user experience.

Storing a data file at multiple different PoP locations may result in the file storage cost increasing proportionally to the number of copies of the data file, e.g., the number of PoP locations. The inventors have recognized and appreciated that opportunities may exist for reducing the storage cost across two or more PoPs while having little or no impact on the performance for the end-user. The methods and techniques discussed herein may reduce the storage cost for distributed storage systems while maintaining a similar performance for the end-user, such as for downloading files to the end-user. Offered is a system in which different portions (and less than the entirety) of a file may be stored at respective PoPs, and the client device of an end-user can download respective parts of the file from two or more such PoPs in parallel, such that the net time to download the complete file would be similar to the time for downloading the complete file from the PoP with the fastest connection (e.g., download speed) to the end-user.

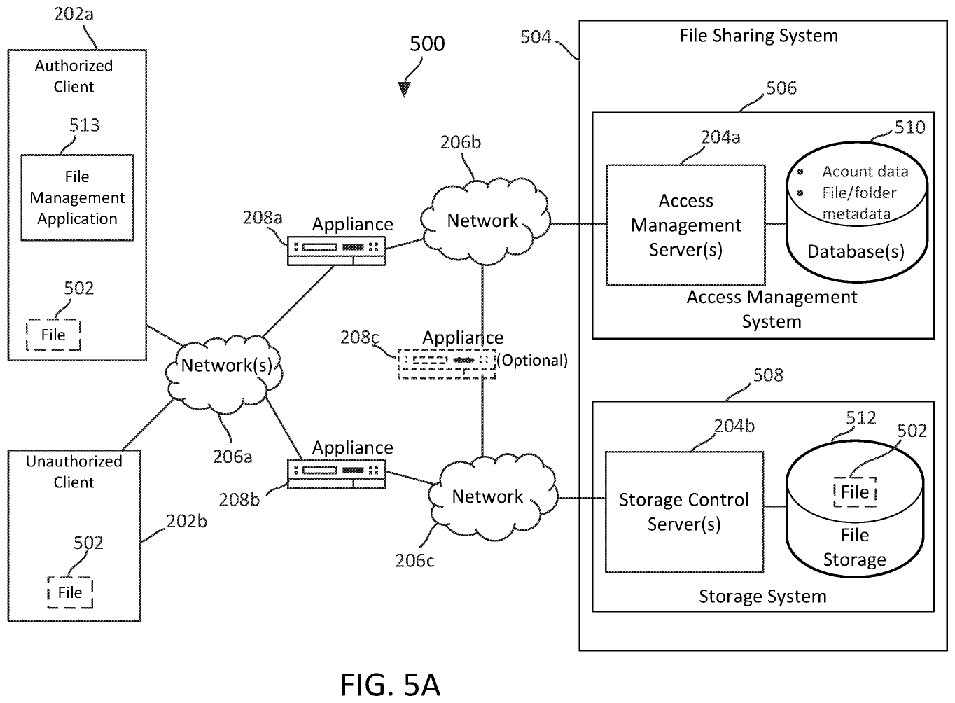

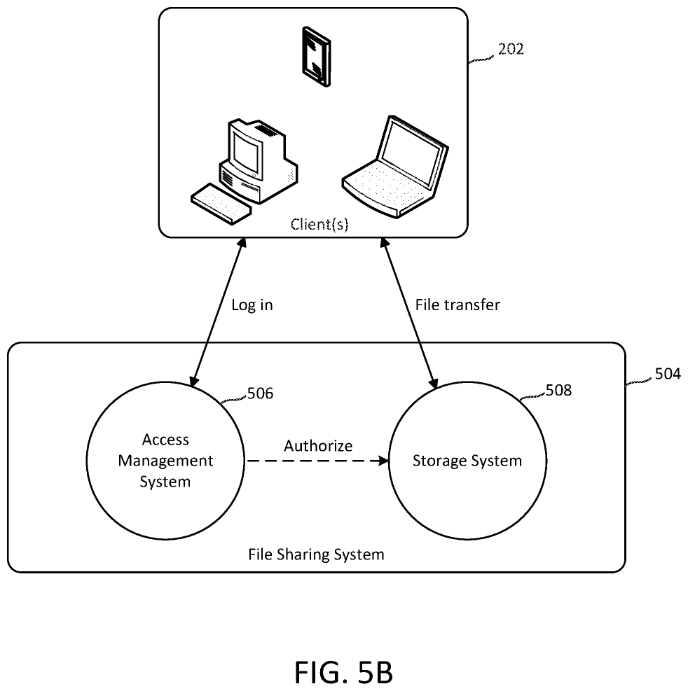

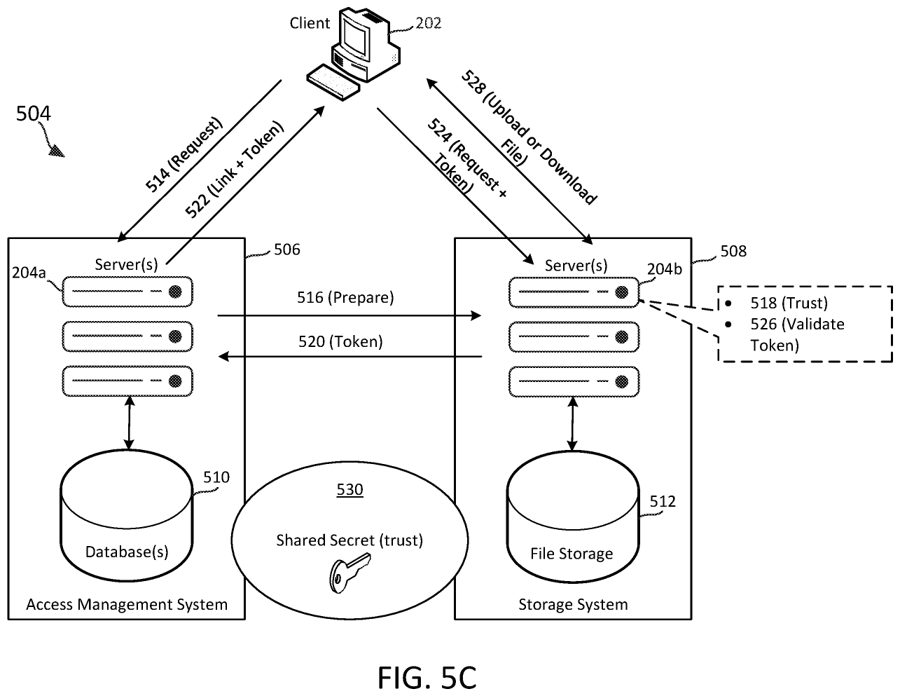

The file sharing system 504 described below (in Section E) in connection with FIGS. 5A-C is an example of a file storage service with which the optimized file distribution described herein may be employed. As Section E explains, in some implementations, one client device 202 may upload a file 502 (shown in FIG. 5A) to a central repository of the file sharing system 504, such as the storage medium(s) 512 shown in FIGS. 5A-C, and another client device 202 may then download a copy of that file 502 from the same repository. As Section E also describes, in some implementations, an access management system 506 may regulate the circumstances in which files 502 may be uploaded and/or downloaded to/from a storage system 508 (including the storage medium 512(s)) by various client devices 202.

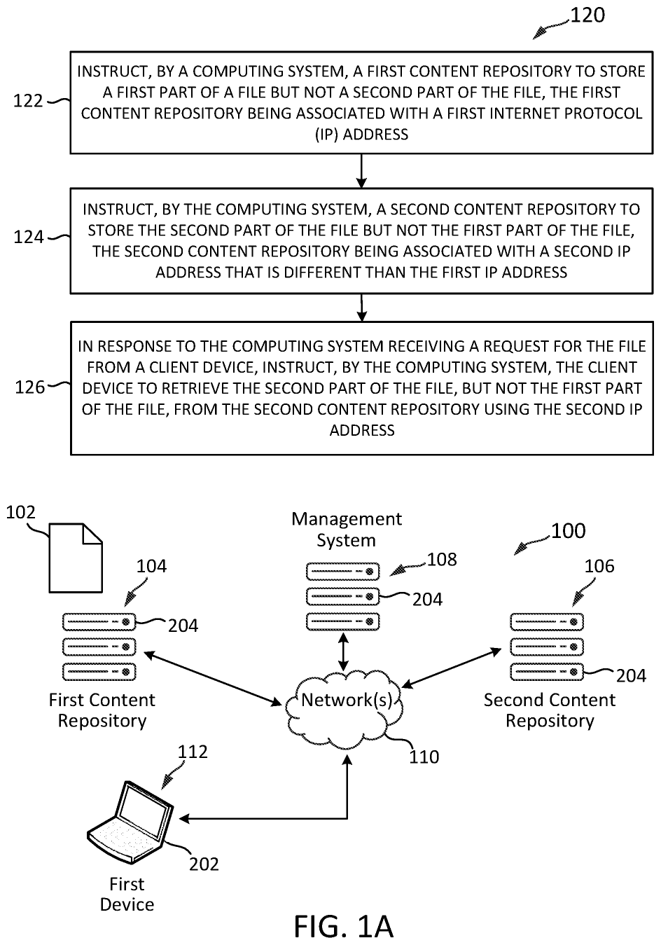

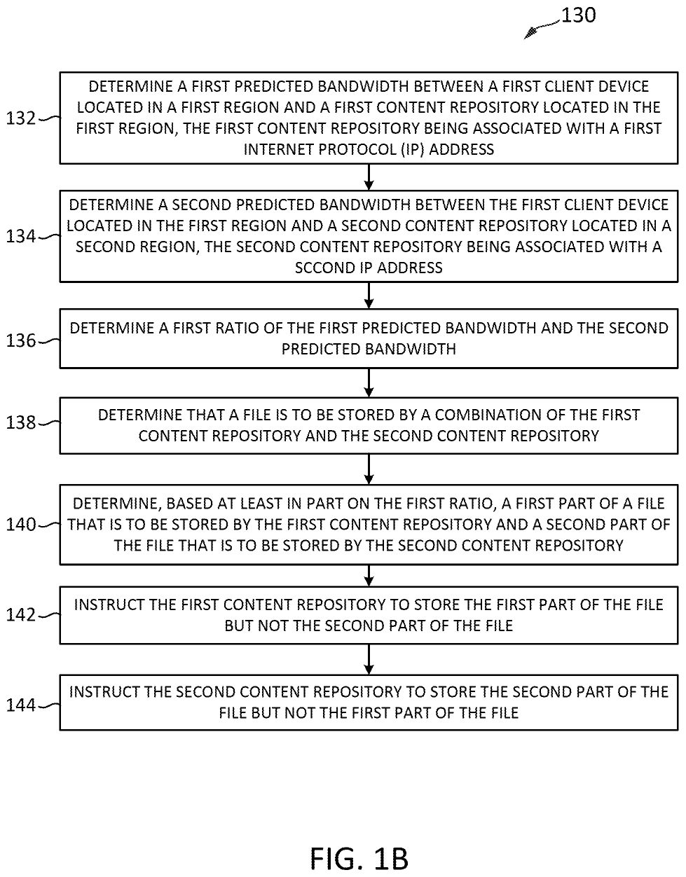

FIG. 1A is a high-level diagram of an example implementation of a computing system 100 that is configured to facilitate optimized distributed storage of a file 102 across multiple PoPs (e.g., a first content repository 104 and a second content repository 106), in accordance with some embodiments of the present disclosure. As shown, in some implementations, the computing system 100 may include a management system 108 that interacts with the first content repository 104 and the second content repository 106 (e.g., via one or more networks 110) to enable aspects of the functionality described herein, as explained in detail below. As an example, in some implementations, the first content repository 104 and the second content repository 106 may be respective storage systems 508 that are associated with different PoPs of the file sharing system 504. For instance, in some implementations, the first content repository 104 may be a first storage system 508 for a first PoP of the file sharing system 504 and may be located in North America, and the second content repository 106 may be a second storage system 508 for a second PoP of the file sharing system 504 and may be located in Asia. Although only two content repositories 104, 106 are shown in FIG. 1A, it should be appreciated that additional content repositories may be employed (e.g., at other PoPs) in some implementations. In some embodiments, the management system 108 may be part of one or both of the content repositories 104, 106 (e.g., as a part of the file sharing system 504). In other embodiments, the management system 108 may be in communication with one or both of the content repositories 104, 106 (e.g., via the network(s) 110). As shown, in some implementations, the first content repository 104, the second content repository 106, and the management system 108 may each include one or more servers 204 (examples of which are described in Sections B-D below).

As illustrated, the first device 112 may include a client device 202 (examples of which are described in Sections B-D below). Although only one such client device 202 is shown in FIG. 1A, it should be appreciated that additional client devices 202 may be employed in some implementations. A client device 202 (e.g., the first device 112) may be in communication with the first content repository 104 and the second content repository 106, and possibly the management system 108, via the network(s) 110. The network(s) 110 may include one of more of the networks 206 described in Sections B-D below, and may, for example, include the internet.

In some implementations, file sharing applications may be installed on the client device 202 and a user may operate such a file sharing application to request to download the file 102 to the client device 202. In some implementations, the user of client device 202 may alternatively use a browser-based file sharing application to request the download of the file 102 to the client device 202. The file management application 513 described in Section E (in connection with FIG. 5A) is an example of a file sharing application that may be used for such purposes. A first example routine 120 that may be performed by one or more of the components of the computing system 100 is illustrated in FIG. 1A.

In some implementations, client devices 202 may initiate a process for downloading the file 102 using a domain name of a file storage service that is implemented by the computing system 100. For example, in embodiments in which the computing system 100 embodies the file sharing system 504 (described in Section E), a user of the first device 112 may select a link that includes a domain name of the file sharing service (e.g., “www.sharefile.com”), as well as an accompanying file download token. Selection of that link may cause the first device 112 to request a Domain Name System (DNS) to resolve the domain name in the link to an Internet Protocol (IP) address for the file storage service. In some such implementations, the domain name for the file storage service may resolve to an IP address of a primary server of the file storage service (e.g., a server of the management system 108), and that primary server may instruct client devices 202 to send further requests to a first IP address of the first content repository 104 and/or a second IP address of the second content repository 106, as described in more detail below. Alternatively, the first content repository 104 and the second content repository 106 may be located in different geographic regions and, for client devices 202 located in a first geographic region, a domain name of a file storage service may resolve to the first IP address of the first content repository 104 whereas, for client devices 202 located in a second geographic region, the domain name of the file storage service may resolve to the second IP address of the second content repository 106.

As shown in FIG. 1A, at a step 122 of the routine 120, a component of the computing system 100 (e.g., the management system 108) may instruct the first content repository 104, which is associated with the first IP address, to store a first part of the file 102 but not a second part of the file 102.

At a step 124 of the routine 120, a component of the computing system 100 (e.g., the management system 108) may instruct the second content repository 106, which is associated with the second IP address, to store the second part of the file 102 but not the first part of the file 102. Examples techniques that may be used by the computing system 100 (e.g., the management system 108) to determine appropriate portions of the file 102 to store in the respective content repositories 104, 106 so as to minimize consumption of storage resources without impacting file download speeds are provided below.

As shown in FIG. 1A, at a step 126 of the routine 120, in response to the computing system 100 receiving a request for the file 102 from the first device 112, the computing system 100 may instruct the first device 112 to retrieve the second part of the file 102, but not the first part of the file 102, from the second content repository 106 using the second IP address. In some implementations, a component of the computing system 100 (e.g., the management system 108) may configure the second content repository 106 to send the second part of the file 102 to the first device 112 in response to the second content repository 106 receiving, from the first device 112, a request for the second part of the file 102.

As noted above, in some implementations, the first device 112 may determine to send the request for the file 102 to an IP address of a primary server of the file storage service (e.g., a server of the management system 108) in response to the domain name for the file storage service resolving to that IP address. In such implementations, the step 126 of the routine 120 may be performed by that primary server (e.g., a server of the management system 108), and the instructions the first device 112 receives from the primary server may enable the first device 112 to obtain the second part of the file 102 from the second content repository 106. Further, in such implementations, in response to the primary server receiving the request for the file 102 from the first device 112, the primary server may additionally instruct the first device 112 to retrieve the first part of the file 102 from the first content repository 104 using the first IP address. Accordingly, in such implementations, the primary server of the file storage service (e.g., a server of the management system 108) may be responsible instructing to the first device 112 to retrieve different parts of the file 102 from respective content repositories, so as to enable the first device 112 to use the respective parts to construct a complete copy of the file 102.

As also noted above, in other implementations, the first device 112 may be located in the same geographic region as the first content repository 106, and the first device 112 may determine to send the request for the file 102 to the first IP address in response to the domain name for the file storage service resolving to the first IP address. For example, the first device 112 may be directed to the first IP address of the first content repository 104 based on a domain name resolution performed by a domain name system (DNS). In such implementations, the step 126 of the routine 120 may instead be performed by the first content repository 104, and the instructions the first device 112 receives from the first content repository 104 may enable the first device 112 to obtain the second part of the file 102 from the second content repository 106. Further, in such implementations, the first content repository 104 may additionally send the first part of the file 102 to the first device 112. Accordingly, in such implementations, the first content repository 104 may be responsible for both (A) sending the first part of the file to the first device 112, and (B) instructing to the first device 112 to retrieve the second part of the file 102 from the second content repository 106, so as to enable the first device 112 to use the respective parts to construct a complete copy of the file 102.

In some implementations, the first device 112 may be located in a first region, and a component of the computing system 100 (e.g., the management system 108) may determine a first predicted bandwidth between the first content repository 104 and the first device 112, and may determine a second predicted bandwidth between the second content repository 106 and the first device 112. In some implementations, based the first predicted bandwidth and the second predicted bandwidth, the computing system 100 may determine a ratio of the first predicted bandwidth and the second predicted bandwidth, and may then determine a first size of a first portion of the file 102 that is to be stored at the first content repository 104 based at least in part on the ratio. In some implementations, the computing system 100 may additionally determine a second size of a second portion of the file 102 that is to be stored at the second content repository 106 based at least in part on the ratio.

In some implementations, the first device 112 may be located in a first region and a second client device 202 (not illustrated) may be located in a second region, and a component of the computing system 100 (e.g., the management system 108) may determine a first predicted bandwidth between the first content repository 104 and the first device 112, and may determine a second predicted bandwidth between the second content repository 106 and the first device 112. In some implementations, the computing system 100 may further determine a first ratio of the first predicted bandwidth and the second predicted bandwidth. In some implementations, the computing system 100 may additionally determine a third predicted bandwidth between the second content repository 106 and the second client device 202 (located in the second region), and may determine a fourth predicted bandwidth between the first content repository 104 and the second client device 202 (located in the second region). In some implementations, the computing system 100 may further determine a second ratio of the third predicted bandwidth and the fourth predicted bandwidth. In some implementations, the computing system 100 may determine a first size of a first portion of the file 102 that is to be stored at the first content repository 104 and/or a second size of a second portion of the file 102 that is to be stored at the second content repository 106 based on the first ratio and/or the second ratio, e.g., based on a lesser of the first ratio and the second ratio.

FIG. 1B shows a second example routine 130 that may be performed by one or more components of the computing system 100 shown in FIG. 1A to determine how different parts of the file 102 are to be distributed across the content repositories 104, 106. For example, in some implementations, the routine 130 may be performed by the management system 108. In some implementations, the routine 130 may be performed in response to the file 102 being initially uploaded to one or more of the content repositories 104, 106 of the computing system 100. Referring to FIG. 1A, the first device 112 and the first content repository 104 may both be located in first region (e.g., North America), and the second content repository may be located in a second region (e.g., Asia).

As shown in FIG. 1B, at a step 132 of the routine 130, the computing system 100 may determine a first predicted bandwidth between the first device 112 (located in the first region) and the first content repository 104 (also located in the first region). The first region may, for example, be defined geographically. In some implementations, the first region may be defined by the DNS. In other implementations, the first region may be defined by a primary server of the file storage service implemented by the computing system 100.

At a step 134 of the routine 130, the computing system 100 may determine a second predicted bandwidth between the first device 112 (located in the first region) and the second content repository 106 (located in the second region). Examples of techniques that may be used to determine such predicted bandwidths are provided below.

At a step 136 of the routine 130, the computing system 100 may determine a first ratio of the first predicted bandwidth and the second predicted bandwidth.

At a step 138 of the routine 130, the computing system 100 may determine that a file 102 is to be stored by a combination of the first content repository 104 and the second content repository 106. In some implementations, the computing system 100 may determine a size of a first portion of the file 102 that is to be stored by the first content repository 104 based at least in part on the first ratio. In some implementations, the computing system 100 may additionally determine a size of a second portion of the file 102 that is to be stored by the second content repository 106 based at least in part on the first ratio.

As noted above, in some implementations, the first device 112 (located in the first region) may receive different parts of the file 102 in parallel from the first content repository 104 and the second content repository 106. As explained in more detail below, in some implementations, the computing system 100 may determine the size of the first portion of the file 102 that is to be stored at the first content repository 104 such that the first device 112 can receive the first portion from the first content repository 104 in about the same time it takes to receive the remaining part(s) of the file from the second content repository 106.

As noted previously, in some implementations, the computing system 100 may additionally determine a third predicted bandwidth between the second content repository 106 and a second client device 202 located in the second region and further may determine a fourth predicted bandwidth between the first content repository 104 and the second client device (located in the second region). In some implementations, the computing system 100 may determine a second ratio of the third predicted bandwidth and the fourth predicted bandwidth. In such implementations, the computing system 100 may determine a size of the first portion of the file 102 that is to be stored at the first content repository 104 based at least in part the first ratio and/or the second ratio, e.g., based on a lesser of the first ratio and the second ratio. Further, in some implementations, the computing system 100 may additionally determine the size the second portion of the file 102 that is to be stored at the second content repository 106 based at least in part the first ratio and/or the second ratio, e.g., based on the lesser of the first ratio and the second ratio.

At a step 140 of the routine 130, the computing system 100 may determine, based at least in part on the first ratio, a first part of the file 102 that is to be stored by the first content repository 104 and a second part of the file 102 that is to be stored by the second content repository 106. In some implementations, the determination of the first part and the second part of the file 102 may additionally or alternatively be based on the second ratio, such as if the second ratio is less than the first ratio.

At a step 142 of the routine 130, the computing system 100 may cause the first content repository 104 to store the first part of the file 102 but not the second part of the file 102.

At a step 144 of the routine 130, the computing system 100 may cause the second content repository 106 to store the second part of the file 102 but not the first part of the file 102.

Additional details and example implementations of embodiments of the present disclosure are set forth below in Section F, following a description of example systems and network environments in which such embodiments may be deployed.

### B. Network Environment

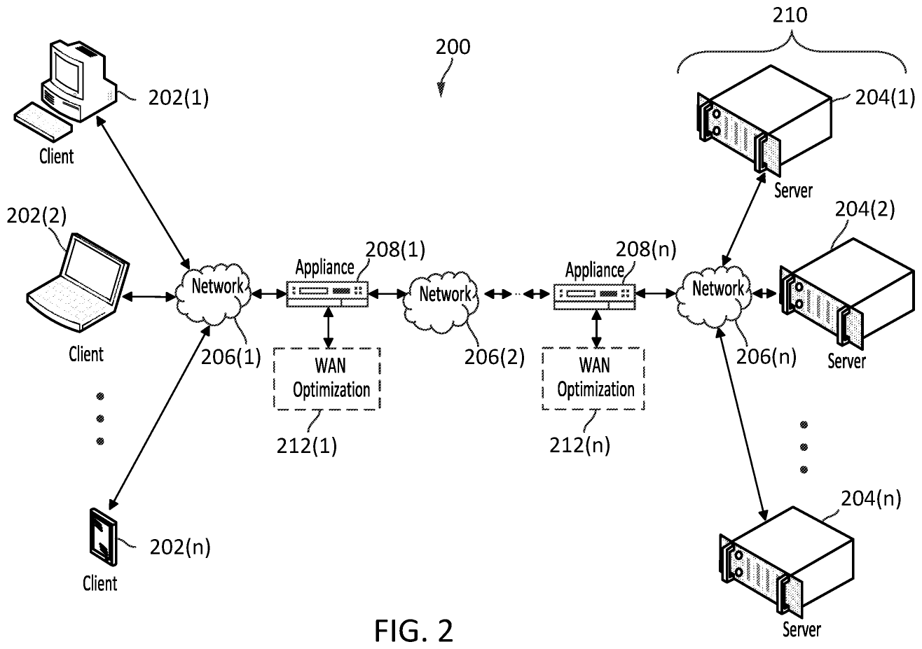

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the client devices 202 and the servers 204, in other embodiments, the client devices 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one or more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, FL, such as Citrix Gateway™ or Citrix ADC™

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, FL, such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of an organization.

### C. Computing Environment

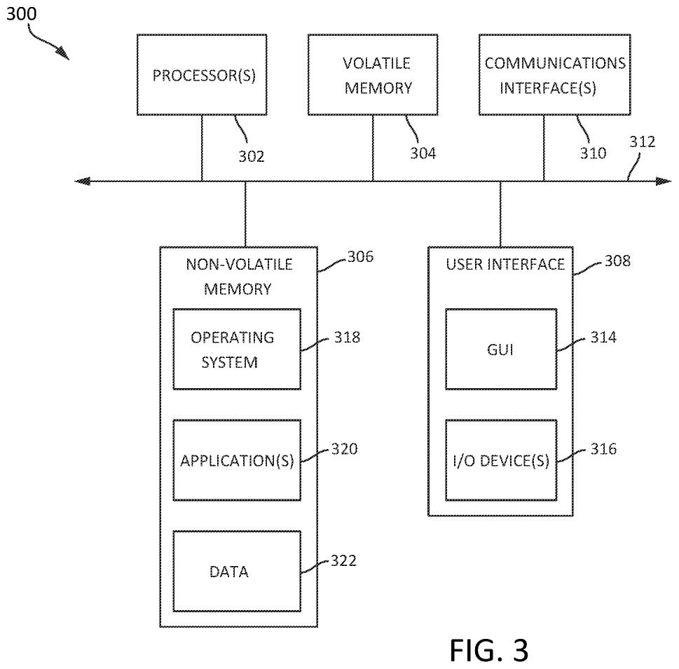

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

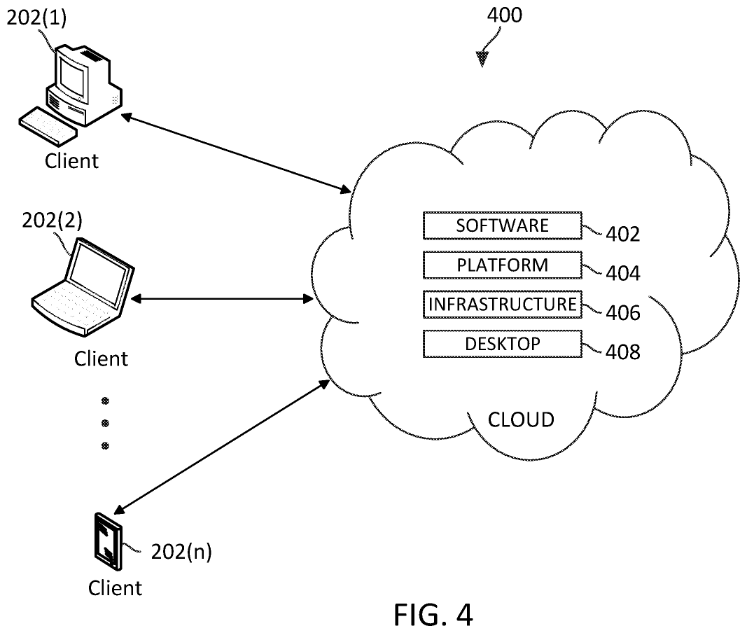

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for uniform resource locator (URL) reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. Citrix ShareFile® from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Washington, or AMAZON WEB SERVICES provided by Amazon.com, Inc., of Seattle, Washington, for example. In the case of Citrix Cloud, Citrix Workspace app may be used as a single-entry point for bringing apps, files and desktops together (whether on-premises or in the cloud) to deliver a unified experience.

### E. Systems and Methods for Providing File Sharing Over Network(s)

FIG. 5A shows an example network environment 500 for allowing an authorized client 202a and/or an unauthorized client 202b to upload a file 502 to a file sharing system 504 or download a file 502 from the file sharing system 504. The authorized client 202a may, for example, be a client 202 operated by a user having an active account with the file sharing system 504, while the unauthorized client 202b may be operated by a user who lacks such an account. As shown, in some embodiments, the authorized client 202a may include a file management application 513 with which a user of the authorized client 202a may access and/or manage the accessibility of one or more files 502 via the file sharing system 504. The file management application 513 may, for example, be a mobile or desktop application installed on the authorized client 202a (or in a computing environment accessible by the authorized client). The ShareFile® mobile app and the ShareFilex desktop app offered by Citrix Systems, Inc., of Fort Lauderdale, FL, are examples of such preinstalled applications. In other embodiments, rather than being installed on the authorized client 202a, the file management application 513 may be executed by a web server (included with the file sharing system 504 or elsewhere) and provided to the authorized client 202a via one or more web pages.

As FIG. 5A illustrates, in some embodiments, the file sharing system 504 may include an access management system 506 and a storage system 508. As shown, the access management system 506 may include one or more access management servers 204a and a database 510, and the storage system 508 may include one or more storage control servers 204b and a storage medium(s) 512. In some embodiments, the access management server(s) 204a may, for example, allow a user of the file management application 513 to log in to his or her account, e.g., by entering a user name and password corresponding to account data stored in the database 510. Once the user of the client 202a has logged in, the access management server 204a may enable the user to view (via the authorized client 202a) information identifying various folders represented in the storage medium(s) 512, which is managed by the storage control server(s) 204b, as well as any files 502 contained within such folders. File/folder metadata stored in the database 510 may be used to identify the files 502 and folders in the storage medium(s) 512 to which a particular user has been provided access rights.

In some embodiments, the clients 202a, 202b may be connected to one or more networks 206a (which may include the Internet), the access management server(s) 204a may include webservers, and an appliance 208a may load balance requests from the authorized client 202a to such webservers. The database 510 associated with the access management server(s) 204a may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202a, 202b are shown is FIG. 5A as stand-alone computers, it should be appreciated that one or both of the clients 202a, 202b shown in FIG. 5A may instead represent other types of computing devices or systems that can be operated by users. In some embodiments, for example, one or both of the authorized client 202a and the unauthorized client 202b may be implemented as a server-based virtual computing environment that can be remotely accessed using a separate computing device operated by users, such as described above.

In some embodiments, the access management system 506 may be logically separated from the storage system 508, such that files 502 and other data that are transferred between clients 202 and the storage system 508 do not pass through the access management system 506. Similar to the access management server(s) 204a, one or more appliances 208b may load-balance requests from the clients 202a, 202b received from the network(s) 206a (which may include the Internet) to the storage control server(s) 204b. In some embodiments, the storage control server(s) 204b and/or the storage medium(s) 512 may be hosted by a cloud-based service provider (e.g., Amazon Web Services™ or Microsoft Azure™). In other embodiments, the storage control server(s) 204b and/or the storage medium(s) 512 may be located at a data center managed by an enterprise of a client 202, or may be distributed among some combination of a cloud-based system and an enterprise system, or elsewhere.

After a user of the authorized client 202a has properly logged in to an access management server 204a, the server 204a may receive a request from the client 202a for access to one of the files 502 or folders to which the logged in user has access rights. The request may either be for the authorized client 202a to itself to obtain access to a file 502 or folder or to provide such access to the unauthorized client 202b. In some embodiments, in response to receiving an access request from an authorized client 202a, the access management server 204a may communicate with the storage control server(s) 204b (e.g., either over the Internet via appliances 208a and 208b or via an appliance 208c positioned between networks 206b and 206c) to obtain a token generated by the storage control server 204b that can subsequently be used to access the identified file 502 or folder.

In some implementations, the generated token may, for example, be sent to the authorized client 202a, and the authorized client 202a may then send a request for a file 502, including the token, to the storage control server(s) 204b. In other implementations, the authorized client 202a may send the generated token to the unauthorized client 202b so as to allow the unauthorized client 202b to send a request for the file 502, including the token, to the storage control server(s) 204b. In yet other implementations, an access management server 204a may, at the direction of the authorized client 202a, send the generated token directly to the unauthorized client 202b so as to allow the unauthorized client 202b to send a request for the file 502, including the token, to the storage control server(s) 204b. In any of the forgoing scenarios, the request sent to the storage control server(s) 204b may, in some embodiments, include a uniform resource locator (URL) that resolves to an internet protocol (IP) address of the storage control server(s) 204b, and the token may be appended to or otherwise accompany the URL. Accordingly, providing access to one or more clients 202 may be accomplished, for example, by causing the authorized client 202a to send a request to the URL address, or by sending an email, text message or other communication including the token-containing URL to the unauthorized client 202b, either directly from the access management server(s) 204a or indirectly from the access management server(s) 204a to the authorized client 202a and then from the authorized client 202a to the unauthorized client 202b. In some embodiments, selecting the URL or a user interface element corresponding to the URL, may cause a request to be sent to the storage control server(s) 204b that either causes a file 502 to be downloaded immediately to the client that sent the request, or may cause the storage control server 204b to return a webpage to the client that includes a link or other user interface element that can be selected to effect the download.

In some embodiments, a generated token can be used in a similar manner to allow either an authorized client 202a or an unauthorized client 202b to upload a file 502 to a folder corresponding to the token. In some embodiments, for example, an “upload” token can be generated as discussed above when an authorized client 202a is logged in and a designated folder is selected for uploading. Such a selection may, for example, cause a request to be sent to the access management server(s) 204a, and a webpage may be returned, along with the generated token, that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In some embodiments, sending a request including such a token to the storage control server(s) 204b (e.g., by selecting a URL or user-interface element included in an email inviting the user to upload one or more files 502 to the file sharing system 504), a webpage may be returned that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In the described embodiments, the clients 202, servers 204, and appliances 208 and/or 212 (appliances 212 are shown in FIG. 2) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may correspond to respective computing systems, groups of computing systems, or networks of distributed computing systems, such as computing system 300 shown in FIG. 3.

As discussed above in connection with FIG. 5A, in some embodiments, a file sharing system may be distributed between two sub-systems, with one subsystem (e.g., the access management system 506) being responsible for controlling access to files 502 stored in the other subsystem (e.g., the storage system 508). FIG. 5B illustrates conceptually how one or more clients 202 may interact with two such subsystems.

As shown in FIG. 5B, an authorized user operating a client 202, which may take on any of numerous forms, may log in to the access management system 506, for example, by entering a valid user name and password. In some embodiments, the access management system 506 may include one or more webservers that respond to requests from the client 202. The access management system 506 may store metadata concerning the identity and arrangements of files 502 (shown in FIG. 5A) stored by the storage system 508, such as folders maintained by the storage system 508 and any files 502 contained within such folders. In some embodiments, the metadata may also include permission metadata identifying the folders and files 502 that respective users are allowed to access. Once logged in, a user may employ a user-interface mechanism of the client 202 to navigate among folders for which the metadata indicates the user has access permission.

In some embodiments, the logged-in user may select a particular file 502 the user wants to access and/or to which the logged-in user wants a different user of a different client 202 to be able to access. Upon receiving such a selection from a client 202, the access management system 506 may take steps to authorize access to the selected file 502 by the logged-in client 202 and/or the different client 202. In some embodiments, for example, the access management system 506 may interact with the storage system 508 to obtain a unique “download” token which may subsequently be used by a client 202 to retrieve the identified file 502 from the storage system 508. The access management system 506 may, for example, send the download token to the logged-in client 202 and/or a client 202 operated by a different user. In some embodiments, the download token may a single-use token that expires after its first use.

In some embodiments, the storage system 508 may also include one or more webservers and may respond to requests from clients 202. In such embodiments, one or more files 502 may be transferred from the storage system 508 to a client 202 in response to a request that includes the download token. In some embodiments, for example, the download token may be appended to a URL that resolves to an IP address of the webserver(s) of the storage system 508. Access to a given file 502 may thus, for example, be enabled by a “download link” that includes the URL/token. Such a download link may, for example, be sent the logged-in client 202 in the form of a “DOWNLOAD” button or other user-interface element the user can select to effect the transfer of the file 502 from the storage system 508 to the client 202. Alternatively, the download link may be sent to a different client 202 operated by an individual with which the logged-in user desires to share the file 502. For example, in some embodiments, the access management system 506 may send an email or other message to the different client 202 that includes the download link in the form of a “DOWNLOAD” button or other user-interface element, or simply with a message indicating “Click Here to Download” or the like. In yet other embodiments, the logged-in client 202 may receive the download link from the access management system 506 and cut-and-paste or otherwise copy the download link into an email or other message the logged in user can then send to the other client 202 to enable the other client 202 to retrieve the file 502 from the storage system 508.

In some embodiments, a logged-in user may select a folder on the file sharing system to which the user wants to transfer one or more files 502 (shown in FIG. 5A) from the logged-in client 202, or to which the logged-in user wants to allow a different user of a different client 202 to transfer one or more files 502. Additionally or alternatively, the logged-in user may identify one or more different users (e.g., by entering their email addresses) the logged-in user wants to be able to access one or more files 502 currently accessible to the logged-in client 202.

Similar to the file downloading process described above, upon receiving such a selection from a client 202, the access management system 506 may take steps to authorize access to the selected folder by the logged-in client 202 and/or the different client 202. In some embodiments, for example, the access management system 506 may interact with the storage system 508 to obtain a unique “upload token” which may subsequently be used by a client 202 to transfer one or more files 502 from the client 202 to the storage system 508. The access management system 506 may, for example, send the upload token to the logged-in client 202 and/or a client 202 operated by a different user.

One or more files 502 may be transferred from a client 202 to the storage system 508 in response to a request that includes the upload token. In some embodiments, for example, the upload token may be appended to a URL that resolves to an IP address of the webserver(s) of the storage system 508. For example, in some embodiments, in response to a logged-in user selecting a folder to which the user desires to transfer one or more files 502 and/or identifying one or more intended recipients of such files 502, the access management system 506 may return a webpage requesting that the user drag-and-drop or otherwise identify the file(s) 502 the user desires to transfer to the selected folder and/or a designated recipient. The returned webpage may also include an “upload link,” e.g., in the form of an “UPLOAD” button or other user-interface element that the user can select to effect the transfer of the file(s) 502 from the client 202 to the storage system 508.

In some embodiments, in response to a logged-in user selecting a folder to which the user wants to enable a different client 202 operated by a different user to transfer one or more files 502, the access management system 506 may generate an upload link that may be sent to the different client 202. For example, in some embodiments, the access management system 506 may send an email or other message to the different client 202 that includes a message indicating that the different user has been authorized to transfer one or more files 502 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 502 the different user wishes to upload to the file sharing system 504. The returned webpage may also include a user-interface element, e.g., in the form of an “UPLOAD” button, that the different user can select to effect the transfer of the file(s) 502 from the client 202 to the storage system 508. In other embodiments, the logged-in user may receive the upload link from the access management system 506 and may cut-and-paste or otherwise copy the upload link into an email or other message the logged-in user can then send to the different client 202 to enable the different client to upload one or more files 502 to the storage system 508.

In some embodiments, in response to one or more files 502 being uploaded to a folder, the storage system 508 may send a message to the access management system 506 indicating that the file(s) 502 have been successfully uploaded, and an access management system 506 may, in turn, send an email or other message to one or more users indicating the same. For user's that have accounts with the file sharing system 504, for example, a message may be sent to the account holder that includes a download link that the account holder can select to effect the transfer of the file 502 from the storage system 508 to the client 202 operated by the account holder. Alternatively, the message to the account holder may include a link to a webpage from the access management system 506 inviting the account holder to log in to retrieve the transferred files 502. Likewise, in circumstances in which a logged-in user identifies one or more intended recipients for one or more to-be-uploaded files 502 (e.g., by entering their email addresses), the access management system 506 may send a message including a download link to the designated recipients (e.g., in the manner described above), which such designated recipients can then use to effect the transfer of the file(s) 502 from the storage system 508 to the client(s) 202 operated by those designated recipients.

FIG. 5C is a block diagram showing an example of a process for generating access tokens (e.g., the upload tokens and download tokens discussed above) within the file sharing system 504 described in connection with FIGS. 5A and 5B.

As shown, in some embodiments, a logged-in client 202 may initiate the access token generation process by sending an access request 514 to the access management server(s) 204b. As noted above, the access request 514 may, for example, correspond to one or more of (A) a request to enable the downloading of one or more files 502 (shown in FIG. 5A) from the storage system 508 to the logged-in client 202, (B) a request to enable the downloading of one or more files 502 from the storage system 508 to a different client 202 operated by a different user, (C) a request to enable the uploading of one or more files 502 from a logged-in client 202 to a folder on the storage system 508, (D) a request to enable the uploading of one or more files 502 from a different client 202 operated by a different user to a folder of the storage system 508, (E) a request to enable the transfer of one or more files 502, via the storage system 508, from a logged-in client 202 to a different client 202 operated by a different user, or (F) a request to enable the transfer of one or more files 502, via the storage system 508, from a different client 202 operated by a different user to a logged-in client 202.

In response to receiving the access request 514, an access management server 204a may send a “prepare” message 516 to the storage control server(s) 204b of the storage system 508, identifying the type of action indicated in the request, as well as the identity and/or location within the storage medium(s) 512 of any applicable folders and/or files 502. As shown, in some embodiments, a trust relationship may be established (step 518) between the storage control server(s) 204b and the access management server(s) 204a. In some embodiments, for example, the storage control server(s) 204b may establish the trust relationship by validating a hash-based message authentication code (HMAC) based on shared secret or key 530).

After the trust relationship has been established, the storage control server(s) 204b may generate and send (step 520) to the access management server(s) 204a a unique upload token and/or a unique download token, such as those as discussed above.

After the access management server(s) 204a receive a token from the storage control server(s) 204b, the access management server(s) 204a may prepare and send a link 522 including the token to one or more client(s) 202. In some embodiments, for example, the link may contain a fully qualified domain name (FQDN) of the storage control server(s) 204b, together with the token. As discussed above, the link 522 may be sent to the logged-in client 202 and/or to a different client 202 operated by a different user, depending on the operation that was indicated by the request.

The client(s) 202 that receive the token may thereafter send a request 524 (which includes the token) to the storage control server(s) 204b. In response to receiving the request, the storage control server(s) 204b may validate (step 526) the token and, if the validation is successful, the storage control server(s) 204b may interact with the client(s) 202 to effect the transfer (step 528) of the pertinent file(s) 502, as discussed above.

### F. Detailed Description of Example Embodiments of the System Introduced in Section A

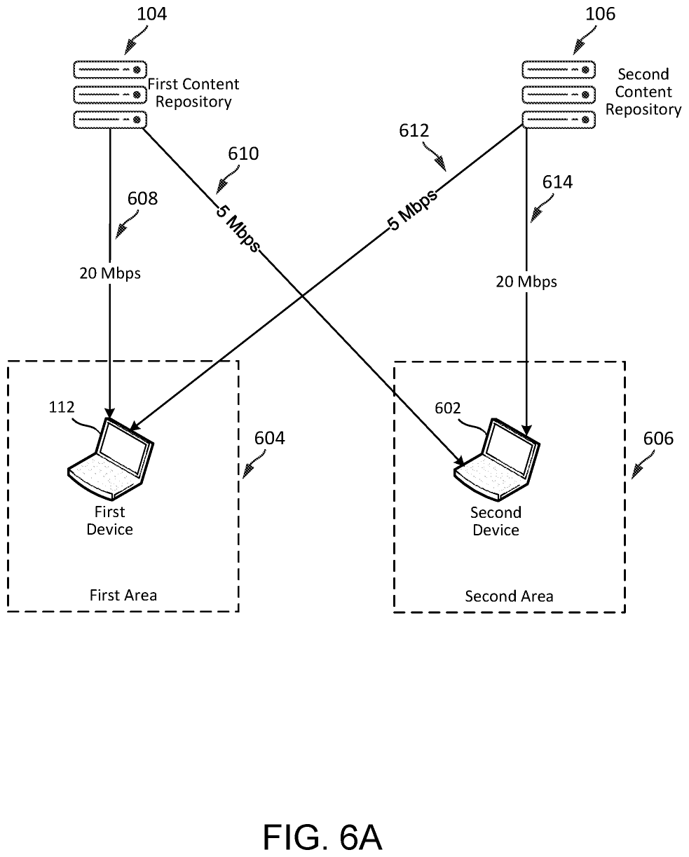

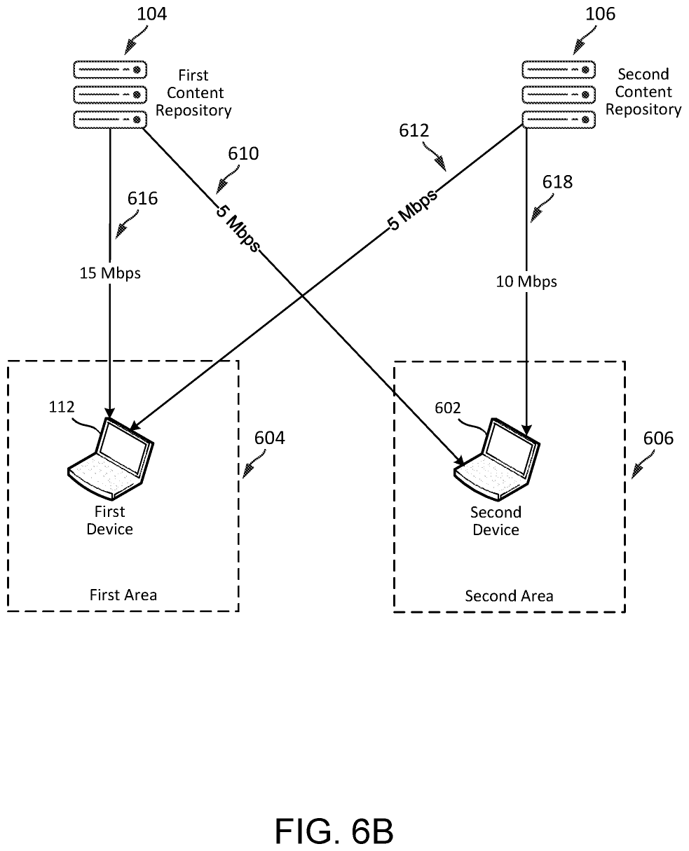

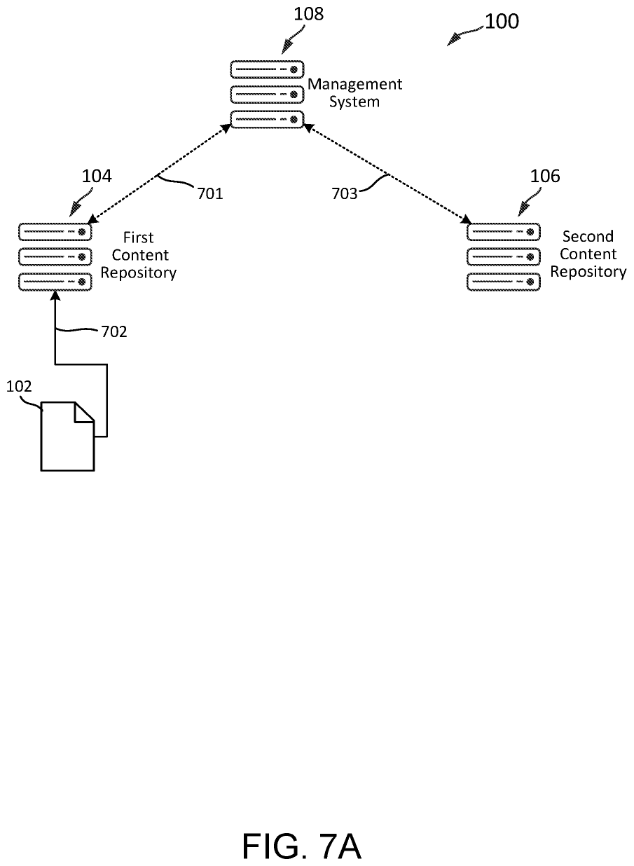

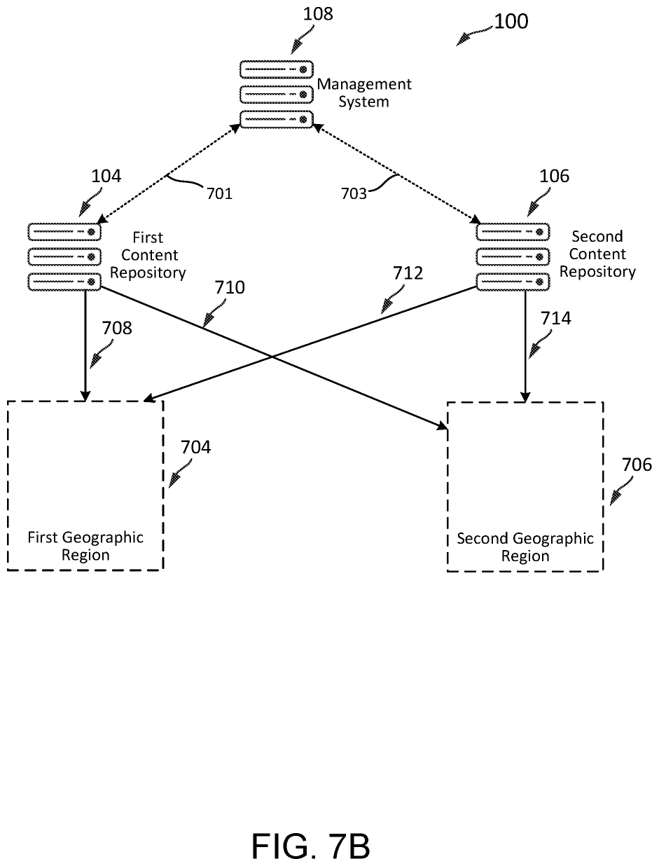

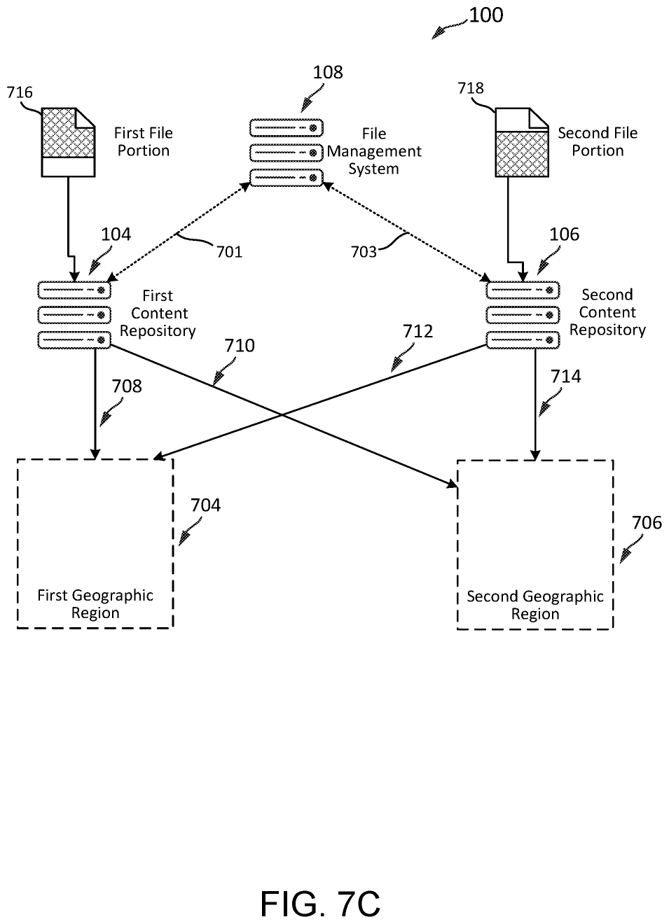

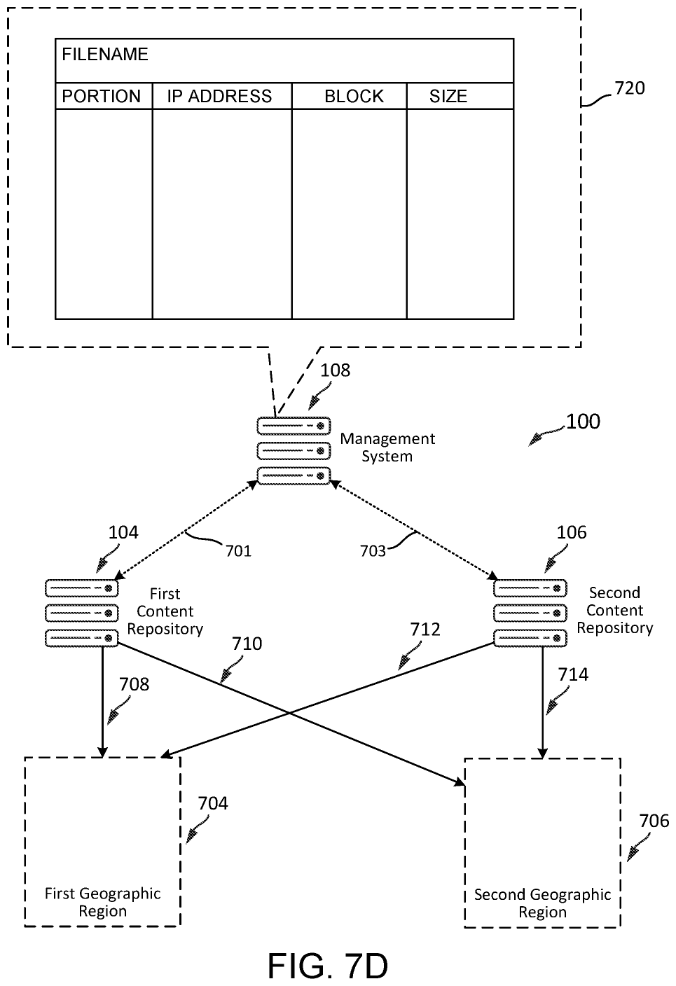

As described above in Section A (with reference to FIG. 1A), at a high level, multiple PoPs, such as the first content repository 104 and the second content repository 106, may together provide optimized content delivery services to client devices 202 (e.g., the first device 112). In particular, as Section A describes, the system 100 may provide such optimized content delivery services to client devices 202 based on factors such as location or connection speed. FIGS. 6A and 6B illustrate example scenarios in which benefits of the system 100 may be realized. As shown, those scenarios may involve the first content repository 104 and the second content repository 106 as well as client devices 202 (e.g., the first device 112 and a second device 602) located in respective areas 604, 606. Those example scenarios will be briefly described in the following paragraphs, and will also be referenced extensively further below in connection with the description of FIGS. 7A-7D, FIGS. 8A and 8B, and FIGS. 9A and 9B.

As shown in FIGS. 6A and 6B, in some implementations, a first PoP (e.g., the content repository 104) may serve client devices 202 (e.g., the first device 112) located in the first area 604 (e.g., North America), and a second PoP (e.g., the second content repository 106) may serve client devices 202 (e.g., the second device 602) located in the second area 606 (e.g., Asia). It should be appreciated that, in some implementations, the service areas (e.g., the first area 604 and the second area 606) may not be different geographic areas, and may instead be defined in some other way, such as by a DNS directive or based on network capabilities. Further, although only two content repositories 104, 106 are shown in FIGS. 6A and 6B, it should be appreciated that additional content repositories may be employed (e.g., at other PoPs) in some implementations.

As explained in detail below, one or more techniques may be performed (e.g., by the management system 108) to predict the download bandwidth that is likely to be available (A) from the first content repository 104 to the first device 112, (B) from the first content repository 104 to the second device 602, (C) from the second content repository 106 to the first device 112, and (D) from the second content repository 106 to the second device 602. The scenarios illustrated in FIGS. 6A and 6B show examples of predicted download bandwidth values that may be so determined. In particular, in the example scenario illustrated in FIG. 6A, a predicted download bandwidth 608 between the first content repository 104 and the first device 112 in the first area 604 is “20” megabits per second (Mbps), and a predicted download bandwidth 614 between the second content repository 106 and a second device 602 in the second area 606 is also “20” Mbps. Additionally, in the example scenario shown in FIG. 6A, a predicted download bandwidth 610 between the first content repository 104 and the second device 602 is “5” Mbps, and a predicted download bandwidth 612 between the second content repository 106 and the first device 112 is also “5” Mbps. The example scenario illustrated in FIG. 6B is identical to the example scenario shown in FIG. 6A, except that a predicted download bandwidth 616 between the first content repository 104 and the first device 112 in the first area 604 is only “15” Mbps (rather than “20” Mbps), and a predicted download bandwidth 618 between the second content repository 106 and a second device 602 in the second area 606 is only “10” Mbps (rather than “20” Mbps).

FIGS. 7A-7D illustrate an example process for uploading and distributing a file 102 across multiple PoPs, and in an optimized fashion, within the computing system 100. As an example, in some implementations, the first content repository 104 and the second content repository 106 may be respective storage systems 508 that are associated with different PoPs of the file sharing system 504 described in Section E. As indicated by arrows 701, 703, in some embodiments, a component of the computing system 100 (e.g., the management system 108) may be in communication, such as via the network(s) 110 (shown in FIG. 1A), with PoPs of the computing system 100 (e.g., the first content repository 104 and the second content repository 106). In other embodiments, the management system 108 may instead be part of one or both of the content repositories 104, 106 (e.g., as a part of one or more storage systems 508 of the file sharing system 504—shows in FIGS. 5A-C). Although only two content repositories 104, 106 are shown in FIGS. 7A-7D, it should be appreciated that additional content repositories may be employed (e.g., at other PoPs) in some implementations.

As indicated by an arrow 702 in FIG. 7A, in some implementations, the file 102 may be uploaded to a PoP, such as the first content repository 104. Such uploading may be accomplished in any of numerous ways. When the first content repository is a storage system 508 of the file sharing system 504, for example, the file may be uploaded using an “upload token” identifying a target folder within the storage system 508, as described in connection with FIG. 5C.

After the file 102 has been uploaded to a PoP, the management system 108 may optimize the storage of the file 102 across the PoPs (e.g., the first content repository 104 and the second content repository 106). As noted above in connection with in FIGS. 6A and 6B, in some scenarios, the download speeds between the PoPs (e.g., the first content repository 104 and the second content repository 106) and client devices 202 in their respective geographic regions (e.g., a first geographic region 704 and a second geographic region 706) may be faster than speeds across regions, such as from the first content repository 104 to a client device 202 in the second geographic region 706. As noted above, in some implementations, the management system 108 may determine predicted download bandwidths between content repositories (e.g., the first content repository 104 and the second content repository 106) and client devices 202, e.g., the first device 112 and the second device 602.

Such predicted download bandwidths may be determined in any of numerous ways. In some implementations, for example, the management system 108 may accumulate data concerning historical download speeds from individual PoPs to one or more client devices 202 within a designated region or area over a recent period of time, and calculate average download speeds between the different PoPs (e.g., the first content repository 104 and the second content repository 106) and the respective areas (e.g., the regions 704, 706). In some implementations, such average download bandwidth values are sufficient to use as the predicted download bandwidths. In other implementations, the management system 108 may additionally or alternatively determine the predicted download bandwidths by monitoring or probing download speeds from the individual PoPs (e.g., the first content repository 104 and the second content repository 106) to one or more client devices 202 in the different areas (e.g., the regions 704, 706), or relying on a separate service (not illustrated) to perform such monitoring/probing. In such implementations, the management system 108 may determine the various predicted download bandwidths based the results of that monitoring/probing.

Referring to FIG. 7B, for example, the management system 108 may determine (A) a predicted download bandwidth 712 (e.g., “5” Mbps) between the second content repository 106 and devices located in the first geographic region 704, and (B) a predicted download bandwidth 708 (e.g., “20” Mbps) between the first content repository 104 and devices located in the first geographic region 704 (e.g., North America). In some implementations, the management system 108 may additionally determine, for the first geographic region 704, a ratio (e.g., “1:4”) between the predicted download bandwidth 712 and the predicted download bandwidth 708, referred to herein as a “first download bandwidth ratio.”

In some implementations, the management system 108 may additionally determine (A) a predicted download bandwidth 710 between the first content repository 104 and devices located in the second geographic region 704, and (B) a predicted download bandwidth 714 between the second content repository 104 and devices located in a second geographic region 704 (e.g., Asia). In some implementations, the management system 108 may further determine, for the second geographic region 704, a ratio between the predicted download bandwidth 710 and the predicted download bandwidth 714, referred to herein as the “second download bandwidth ratio.”

In the example scenario illustrated in FIG. 6A, the first download bandwidth ratio for the first device 112 in the first area 604 may be “5” Mbps to “20” Mbps, or 1:4. As the predicted download speeds are similar for the second device 602 in the second area 606, the second download bandwidth ratio would be the same, with a ratio of “5” Mbps to “20” Mbps, or 1:4.

As shown in FIG. 7C, in some implementations, the management system 108 may use the first download bandwidth ratio and/or the second download bandwidth ratio, determined as described above, to determine optimally sized file portions (e.g., first file portion 716 and second file portion 718) to store at the content repositories 104, 106. As previously described in Section A, by directing a client device 202 to retrieve different parts of the file 102 from two or more content repositories (e.g., the first content repository 104 and the second content repository 106), a collective storage savings for the file may be achieved, ideally without affecting the time to download the requested file to the client device 202, by using parallel connections to the client devices 202 from the two or more content repositories.

In some implementations, after determining the first download bandwidth ratio, the management system 108 may determine at least one portion size for the file portions that are to be stored at the respective content repositories (e.g., the first content repository 104 and the second content repository 106), while ensuring that the distributed portions are combinable to yield the entirety of the file 102. For example, in a scenario in which the file 102 is to be distributed across only two content repositories (e.g., the first content repository 104 and the second content repository 106), the management system 108 may (A) cause the first content repository 104 to store a first file portion 716, and (B) cause the second content repository 106 to store a second file portion 718, such that one or more parts of the first file portion 716 and one or more parts of the second file portion 718 can be combined to yield the entirety of file 102.

In some implementations, the management system 108 may compare the first download bandwidth ratio and the second download bandwidth ratio and select the lesser of the compared download bandwidth ratios. The selected bandwidth ratio may then be used to determine on optimal a file portion size (e.g., 80%) that is to be stored at each of the content repositories 104, 106. As described in more detail below, in some implementations, that optimal file portion size may then be applied to determine the file part(s) that are to be stored at the respective content repositories 104, 106. In other implementations, as also described in more detail below, different optimal file portion sizes may be determined for respective content repositories, with each such optimal file portion size being determined based on the bandwidth ratio for the geographic region serviced by that content repository. In such implementations, a minimum file portion size (e.g., 50% when the file is to be distributed across two content repositories) may additionally be determined to ensure that, for a client device 202 in any region, a combination of part(s) from the respective file portions would be sufficient to reconstruct the entirety of the file 102.

Continuing the example scenario illustrated in FIG. 6A, the file 102 may be divided into five parts (e.g., parts A through E) based on the determined 1:4 download bandwidth ratio. The file management system 108 may determine that the first content repository 104 is to store parts A through D of the file 102 (as components of the first file portion 716), and that the second content repository 104 is to store (at least) part E of the file 102 (as a component of the second file portion 718). A request by the first device 112 to download the file 102 may thereafter be serviced by the computing system 100 by performing downloads, in parallel, from the first content repository 104 to the first device 112 and from the second content repository 106 to the first device 112, with parts A-D being downloaded from the first content repository 104 and part E being downloaded from the second content repository 106. Based on the predicted download bandwidth 608, the time required for the first device 112 in the first area 604 to download the parts A through D from the first content repository 104 is expected to be approximately the same as the time required for the first device 112 to download part E of the file 102 from the second content repository 106. For example, using the 1:4 download bandwidth ratio from FIG. 6A, if the file 102 has a size of “10” gigabytes (GB), parts A through D may have a total size of “8” GB, and part E may have a size of “2” GB. Based on the predicted download bandwidth 608 of “20” Mbps and the predicted download bandwidth 612 of “5” Mbps, the time taken to download parts A through D should be about the same as the time taken to download part E.

Further continuing the example scenario illustrated in FIG. 6A, to provide similar performance for the second device 602 located in the second area 606, the file management system 108 may determine that the second content repository 106 is to store four parts of the file 102 (including part E reference above, e.g., parts B through E), and that the first content repository 104 is to store (at least) one of the five parts of the file (e.g., part A) that is not stored at the second content repository 106. Similar to the first device 112 in the first area 604, the second device 602 may download the four parts (e.g., parts B through E) from the second content repository 106 and the one part (e.g., part A) from the first content repository 104, in parallel, in a relatively similar amount of time based on the example predicted bandwidths shown in FIG. 6A (e.g., the predicted bandwidths 610, 614).

In the example scenario illustrated in FIG. 6A, by storing only four of the five parts of the file 102 at the respective content repositories, a 20% storage reduction may be achieved. For example, if the file 102 is “10” gigabytes, general practice distribution of the file 102 may result in storing a complete copy of the file 102 at the respective content repositories. Thus, resulting in a total of “20” gigabytes of storage for the file 102 for the example two content repositories (e.g., the first content repository 104 and the second content repository 106) of FIG. 6A. In other words, using existing techniques, the file storage cost increases proportionally with the number of content repositories. Using the methods and techniques described herein for optimized distributed storage, the same performance may be delivered to the end-users of the client devices 202 (e.g., the first device 112 and the second device 602) while storing only 80% of the file 102 at the respective content repositories, thus consuming only “16” gigabytes of total storage.

As noted previously, in the example scenario illustrated in FIG. 6A, parts of the file 102 that are stored across the two content repositories may be combined to reconstruct the entire file 102. Dividing the file into five parts, for example, may result in five distinct parts: part A, part B, part C, part D, and part E. Parts A, B, C, and D may be stored at the first content repository 104 and parts B, C, D, and E may be stored at the second content repository 106. As such, in such a scenario, a client device 202 in the first area 604 (e.g., the first device 112) may obtain a complete copy of the file 102 by obtaining parts A, B, C and D from the first content repository 104 and obtaining part E from the second content repository 106. Similarly, a client device 202 in the second area 606 (e.g., the second device 602) may obtain a complete copy of the file 102 by obtaining parts B, C, D and E from the second content repository 106 and obtaining part A from the first content repository 104. And significantly, such downloads of the file 102 to client devices 202 in the respective areas 604, 606 can be achieved in about the same time as it would have taken, in a conventional system, for a client device 202 in the first area 604 (e.g., the first device 112) to download the entirely of the file 102 from the first content repository 104, or for a client device 202 in the second area 606 (e.g., the second device 602) to download the entirely of the file 102 from the second content repository 106.

In the example scenario illustrated in FIG. 6A, the predicted download bandwidths within areas (e.g., the predicted download bandwidths 608, 614) and between areas (e.g., the predicted download bandwidths 610, and 612) are relatively similar, and thus the optimal portion size (i.e., 80% of the file) stored at the content repositories 104, 106 is similar. In the example scenario illustrated in FIG. 6B, the predicted download bandwidths within areas (e.g., the predicted download bandwidths 616, 618) are different, thus resulting in download bandwidth ratios that are different for the respective areas 604, 606. In particular, for the example scenario illustrated in FIG. 6B, the first bandwidth ratio for client devices 202 in the first area 604 is “5” Mbps to “15” Mbps, or 1:3, based on the predicted download bandwidths 612 and 616, whereas the second bandwidth ratio for client devices 202 in the second area 606 is “5” Mbps to “10” Mbps, or 1:2, based on the predicted download bandwidths 610 and 618.

In such scenarios, where the predicted bandwidths within regions and/or the predicted bandwidths across regions are different, either of two alternative approaches may be implemented. In a first approach, the two or more bandwidth ratios may be compared to determine the lowest ratio. In the example scenario illustrated in FIG. 6B, the first bandwidth ratio of 1:3 is less than the second bandwidth ratio of 1:2. The determined lesser of the bandwidth ratios may then be applied to both of the example regions (e.g., the first area 604 and the second area 606). For example, based on the first bandwidth ratio of 1:3, the management system 108 may determine that 75% is an optimal file portion size for both the first area 604 and the second area 606. Thus, by selecting the first bandwidth ratio of 1:3, the management system 108 may determine to store different 75% portions of the file 102 at the respective content repositories (e.g., the first content repository 104 and the second content repository 106), as described above.

In a second approach, where the predicted bandwidths within regions and/or the predicted bandwidths between regions are different, different optimal file portion sizes may be determined for respective regions, with the optimal portion size for a given region being determined based on the bandwidth ratio for that region. In some implementations, the management system 108 may further impose a requirement that a respective content repository maintain a minimum file portion size to support the other regions. For example, with the example scenario illustrated in FIG. 6B, based on the first bandwidth ratio of 1:3, the management system 108 may determine an optimal file portion size of 75% for the first content repository 104 and also determine a minimum file portion size of 25% for the second content repository 106. Further, based on the second bandwidth ratio of 1:2, the management system 108 may determine an optimal file portion size of 66% for the second content repository 104 and also determine a minimum file portion size of 33% for the first content repository 104. The management system 108 may divide the file accordingly between the respective content repositories based on the determined first bandwidth ratio and second bandwidth ratio. For example, in applying the first bandwidth ratio, the 25% of the file 102 to be stored with the second content repository 106 may be included in the 66% of the file 102 that the second content repository 106 stores based on the second bandwidth ratio. Conversely, in applying second bandwidth ratio, the 33% of the file 102 to be stored with the first content repository 104 may be included in the 75% of the file 102 that the first content repository 104 stores based on the first bandwidth ratio. Greater storage savings may thus be achieved in applying the second approach.

As shown in FIG. 7D, in some implementations, the management system 108 may receive the predicted download bandwidth data (e.g., the predicted download bandwidths 708, 710, 712, 714) and determine the bandwidth ratios for the respective regions and associated content repositories (e.g., the first content repository 104 and the second content repository 106). The management system 108 may determine the optimal file portion sizes for the respective content repositories and may also determine which parts of the file 102 are to be stored at the respective content repositories. Based on this information, the management system 108 may generate a portion mapping file 720 for a storage optimized file (e.g., the file 102). In some implementations, the management system 108 may generate different portion mapping files 720 for use in the different regions 704, 706.

For example, the management system 108 may generate a first portion mapping file 720 for use in servicing requests for the first file 102 from client devices 202 located in the first region 704 (e.g., the first device 112), and a second portion mapping file 720 for use in servicing requests for the first file 102 from client devices 202 located in the second region 706 (e.g., the second device 602). In such implementations, the first portion mapping file 720 may indicate that a requesting client device 202 is to download the majority (e.g., parts A through D) of the file 102 from the first content repository 104 and the remainder of the file (e.g., part E) from the second content repository 106. Similarly, the second portion mapping file 720 may indicate that a requesting client device 202 is to download the majority (e.g., parts B through E) of the file 102 from the second content repository 106 and the remainder of the file (e.g., part A) from the first content repository 104.

In some implementations, as shown in FIG. 7D, the portion mapping file 720 may identify the file 102 by the file name and provide a mapping for retrieval of the respective file parts (e.g., parts A through E). The mapping of the portion mapping file 720 may identify two or more parts of the file 102. In some implementations, the mapping of a respective part may include the IP address identifying the content repository storing that part. In some implementations, a client device 202 (e.g., first device 112) requesting a file 102 may receive the portion mapping file 720 and be directed to the corresponding content repositories to request the necessary parts of the file 102 to reconstruct a complete copy of the file 102.

The portion mapping file 720 may include a pointer to a starting data block of the file portion and a data block amount, or size, to identify the segment of data the content repository is to transmit. As discussed above in connection with the example scenario illustrated in FIG. 6A, in some implementations, the first content repository 104 and the second content repository 106 may store file parts equivalent to different 80% portions of the file 102. In that example scenario, a first device 112 (in the first area 604) that requests the file 102 may receive a portion mapping file 720 identifying two file segments, a first segment (e.g., including parts A through D) stored at the first content repository 104 and a second segment (e.g., including part E) stored at the second content repository 106. Additionally, the portion mapping file 720 may provide, in relation to the first segment stored at the first content repository 104, a first data block pointer to an initial block of the first segment and a first indicator of the size of the first segment (e.g., the entire 80% of the file 102 stored at the first content repository 104). The portion mapping file 720 may further provide, in relation to the second segment stored at the second content repository 106, a second data block pointer to an initial data block within the second segment and a second indicator of the size of the second segment (e.g., the remaining 20% of the file 102 stored at the second content repository 106). The segment identified by the second data block pointer and size indicator (e.g., the 20% of the file 102 not received from the first content repository 104) may compliment the first segment to be received from the first content repository 104, such that the client device 202 may reconstruct the complete file 102 using the first and second received segments.

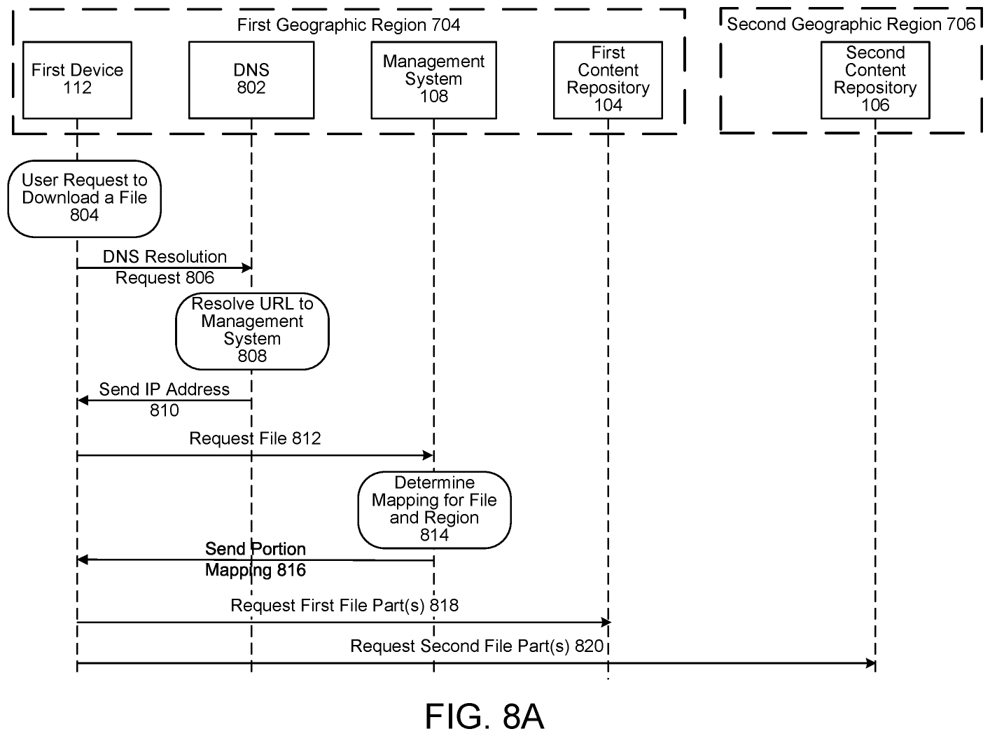

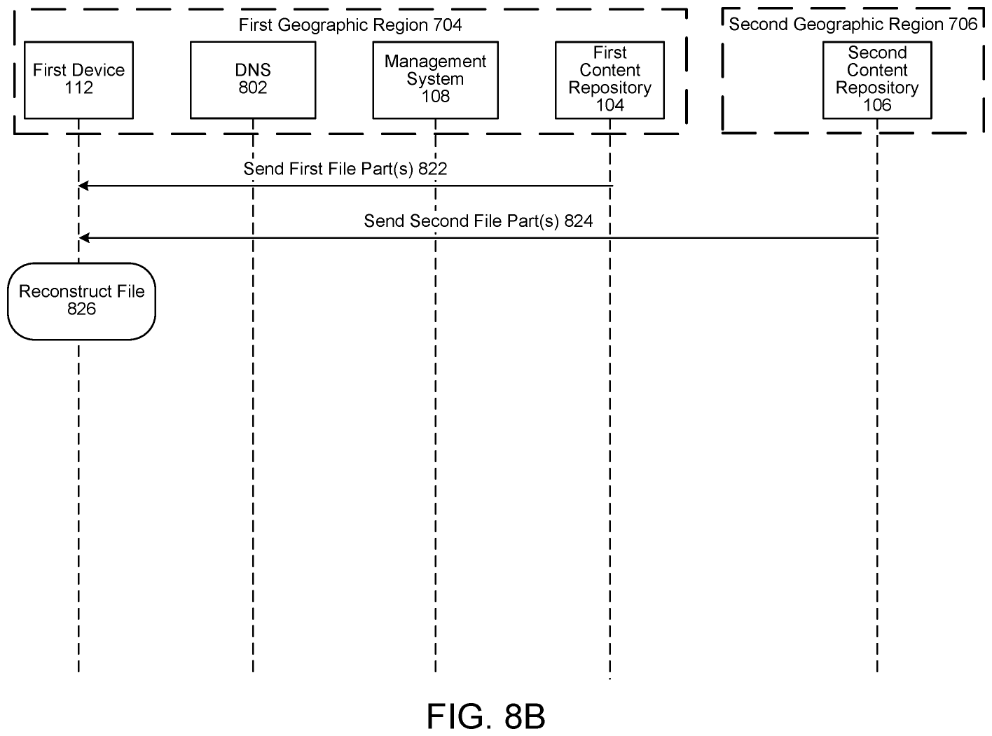

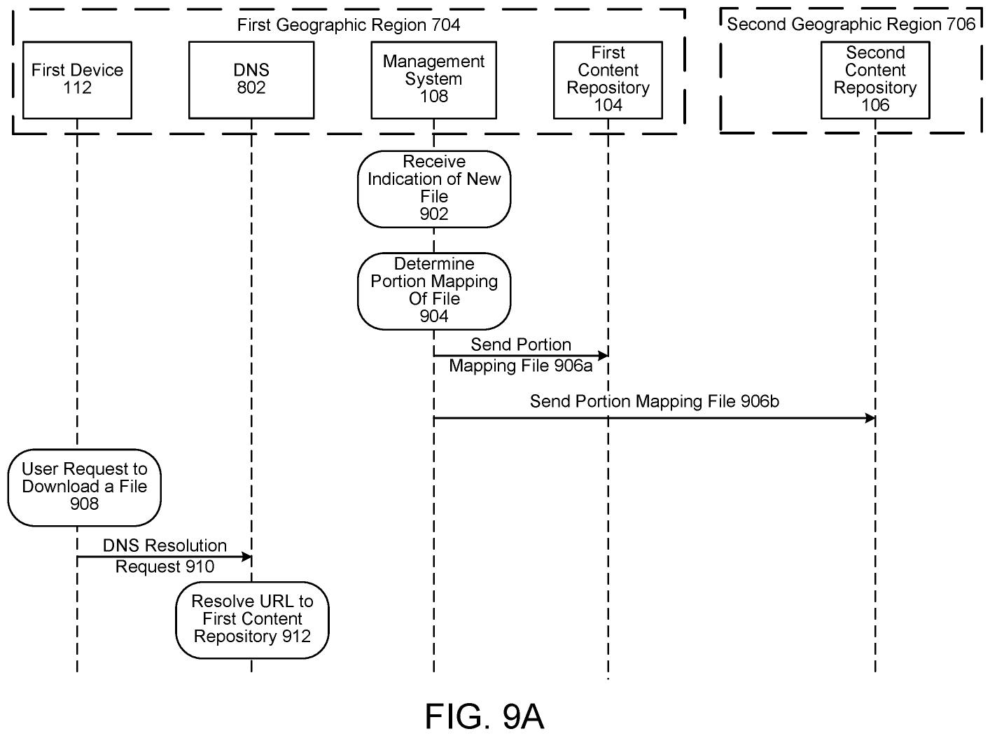

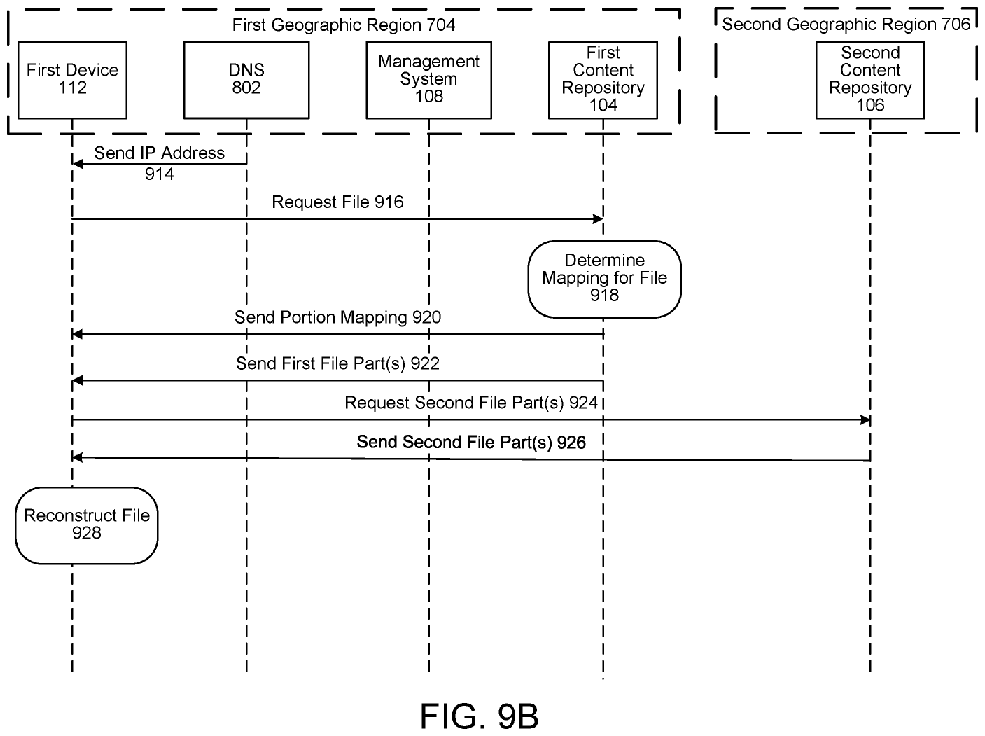

FIGS. 8A and 8B illustrate a first example process for a file download through optimized distributed storage in a scenario in which a domain name for the computing system 100 (e.g., “www.sharefile.com”) resolves to an IP address of the management system 108. FIGS. 9A and 9B, on the other hand, illustrate a second example process for a file download through optimized distributed storage in a scenario in which a domain name for the computing system 100 (e.g., “www.sharefile.com”) instead resolves to an IP address of one of the content repositories 104, 106. As shown, both such scenarios may involve a client device 202 (e.g., the first device 112) and at least two content repositories (e.g., the first content repository 104 and the second content repository), as well as a DNS 802 (e.g., embodied by one or more servers 204) and the management system 108 (e.g., embodied by one or more servers 204). Although only two content repositories 104, 106 are shown in the illustrated examples, it should be appreciated that additional content repositories may be employed (e.g., at other PoPs) in some implementations. Further, although the illustrated examples show the DNS 802 and the management system 108 as being located within the first geographic region 704, it should be appreciated that, in other embodiments, the DNS 802 and/or the management system 108 may instead be located elsewhere. For example, in some embodiments, one or both of the DNS 802 and the management system 108 may be located within the second geographic region 706. In other embodiments, one or both of the DNS 802 and the management system 108 may be located in another geographic region outside of the first geographic region 704 and the second geographic region 706. Finally, although the illustrated examples show the management system 108 as being separate from the content repositories 104, 106, it should be appreciated that, in some implementations, the management system 108 may instead be integrated within and/or co-located with the first content repository 104 and/or the second content repository 106.

The first example scenario, in which a domain name for the computing system 100 (e.g., “www.sharefile.com”) resolves to an IP address of the management system 108, will now be described in connection with FIGS. 8A and 8B. As shown in FIG. 8A, in some implementations, the first device 112 (e.g., a client device 202) may receive (804) a user input requesting to download a file (e.g., the file 102), such as via a client application installed on the client device 202. In some implementations, a user may operate a client device 202 to request a download of a file to the user's client device 202 (e.g., the first device 112) through a client application, such as the ShareFile® mobile app and the ShareFile® desktop app offered by Citrix Systems, Inc., of Fort Lauderdale, FL. In some implementations, the client application may include a graphical user interface (GUI) providing navigation tools to obtain a link to download the file. In some implementations, the client device 202 may receive a message, such as an email or text message, which may include a link, such as a URL, or command to download the file via the client application. For example, in embodiments in which the computing system 100 embodies the file sharing system 504 (described in Section E), a user of the first device 112 may select a link that includes a domain name of the file sharing service (e.g., “www.sharefile.com”), as well as an accompanying file download token.

As shown in FIG. 8A, the first device 112 may, in response to receiving (804) the user input requesting the file 102, send (806) a DNS resolution request using a URL (e.g., “www.sharefile.com”) to the DNS 802. The DNS 802 may resolve (808) the URL to a first IP address for the management system 108. Upon resolving the URL to the IP address of the management system 108, the DNS 802 may send (810) the first IP address of the management system 108 to the first device 112.

In some implementations, in response to receiving the IP address of the management system 108, the first device 112 may request (812) the file (e.g., the file 102) from the management system 108. As described above with reference to FIGS. 7A-7D, the file 102 may be divided into file parts (e.g., parts A through E) that are stored across multiple content repositories (e.g., the first content repository 104 and the second content repository 106) to optimize storage of the file 102.

As described with reference to FIG. 7D, the management system 108 may store a portion mapping file 720 corresponding to the file 102. In response to receiving the request for the file 102, the management system 108 may determine (814) the portion mapping file 720 applicable to the file 102 and the first device 112. In some implementations, this determination may be based on identifying a location or region of the first device 112 and the corresponding PoP (e.g., the first content repository 104) for that location/region.

In some implementations, the management system 108 may send (816) the portion mapping file 720 to the first device 112. In some implementations, the portion mapping file 720 may identify, such as by IP address, the content repositories (e.g., the first content repository 104 and the second content repository 106) which store the respective parts of the file 102 (e.g., parts A through E) of file 102.

In some implementations, in response to receiving the portion mapping file 720, the first device 112, such as directed by a client application using the portion mapping file 720, may request (818) one or more parts of the file 102 (e.g., parts A through D of the first file portion 716) from the first content repository 104. Additionally, as indicated by the portion mapping file 720, the first device 112 may additionally request (820) one or more parts of the file 102 (e.g., part E of the second file portion 718) from the second content repository 106. As previously described in relation to FIG. 7D, the portion mapping file 720 may identify data blocks and segment sizes to request from the respective content repositories. The data provided in the portion mapping file 720 may thus provide the first device 112 with information that is sufficient to identify the parts necessary to reconstruct the file 102 and as well as the content repositories that are to provide such parts.

As shown in FIG. 8B, in some implementations, in response to receiving (818) the request for the requisite part(s) of the first file portion 716, the first content repository 104 may send (822) those part(s) to the first device 112. Further, in response to receiving (820) the request for the requisite part(s) of the second file portion 718, the second content repository 106 may send (824) those part(s) to the first device 112. Finally, upon receiving the various parts of the file 102 from the different content repositories (e.g., the first content repository 104 and the second content repository 106), the client application of the first device 112 may reconstruct (826) the file 102 using those parts.

The second example scenario, in which a domain name for the computing system 100 (e.g., “www.sharefile.com”) resolves to an IP address of one of the content repositories 104, 106, will now be described in connection with FIGS. 9A and 9B. As shown in FIG. 9A, the management system 108 may receive (902) an indication of a new file upload (e.g., the file 102). In some implementations, the management system 108 may determine (904) portion mapping file(s) for the file 102 based on the predicted download bandwidths, e.g., as described in reference to FIGS. 7A-7D. As shown, the management system 108 may then send (906a) a determined portion mapping file to the first content repository 104, and may also send (906b) a determined portion mapping file to the second content repository 106. In some implementations, different portion mapping files may be sent to respective content repositories.

In some implementations, the first device 112 may receive (908) a user input requesting to download a file, such as via a client application installed on the first device 112. Examples of such requests are described above in connection with the step 804 (shown in FIG. 8A) of the first example scenario. In response to receiving (908) the user input requesting the file 102, the first device 112 may send (910) a DNS resolution request to the DNS 802. The DNS 802 may resolve (912) the URL to an IP address for the first content repository 104.

As shown in FIG. 9B, in some implementations, the DNS 802 may send (914) the IP address for the first content repository 104 to the first device 112. Using the IP address provided from the DNS resolution, the first device 112 may request (916) the file 102 from the first content repository 104.

In response to receiving the request for the file 102, the first content repository 104 may determine (918) one or more portion mapping files 720 corresponding to the requested file 102. In some implementations, the first content repository 104 may send (920) the determined portion mapping file(s) 720 to the first device 112. In some implementations, the portion mapping file(s) 720 may identify, such as by IP address, one or more content repositories (e.g., the second content repository 106) from which the first device 112 is to obtain one or more parts of the file (e.g., part E of the second file portion 718) of the file 102. In some implementations, the first content repository 104 may further send (922) the remaining parts of the file (e.g., parts A through D of the first file portion 716) stored at the first content repository 104.

In some implementations, in response to receiving the portion mapping file(s) 720, the first device 112, such as directed by a client application using the portion mapping file(s) 720, may request (924) one or more parts of the file 102 (e.g., part E of the second file portion 718) from the second content repository 106. As previously described in relation to FIG. 7D, the portion mapping file 720 may identify data blocks and segment sizes to request from the respective content repositories. The data provided in the portion mapping file(s) 720 may thus identify the various parts of file 102 that are to be obtained from the other content repositories (e.g., the second content repository 106) to enable the first device 112 to reconstruct the file 102.

In some implementations, in response to receiving (924) the request for the part(s) of the second file portion 718, the second content repository 106 may send (926) those part(s) to the first device 112. In some implementations, upon receiving various parts of the file 102 from the different content repositories (e.g., the first content repository 104 and the second content repository 106), the client application of the first device 112 may use those parts to reconstruct (928) the file 102.

In some implementations, more than two content repositories may be utilized if the content repositories are able to provide services to client devices 202 of different regions and the client devices 202 are able to employ multiple parallel connections. In some implementations, when more than two content repositories are employed for optimized distributed storage, the storage size required at the individual content repositories may be additionally reduced. For example, if a bandwidth ratio for three content repositories is determined to be 3:1:1, then the optimal file portion size at the respective three repositories may be 60% of the original file.

In some implementations, optimized distributed storage may incorporate data resiliency. Utilizing three or more content repositories, the file portions may be distributed such that the same segments of the file portions are stored at multiple, but fewer than all, of the content repositories. Thus, if any one of the content repositories were to go down, the file 102 may continue to be reconstructed based on accessing the file segments available from the remaining content repositories.

For example, utilizing three content repositories and dividing the file 102 into three parts, the file portion stored at the first content repository may include part “1” and part “2” of the file 102, the file portion stored at the second content repository may include part “2” and part “3” of the file 102, and the file portion stored at the third content repository may include part “1” and part “3” of the file 102. Optimized distributed storage may thus be achieved as the respective content repositories store at least 66% of the file and thereby reduce the storage cost by 33%. Further, in such a scenario, data resiliency would be achieved as an individual part of the three parts of the file would be stored at two of the three content repositories. Should one of the three content repositories go down or become inaccessible, a client device 202 would still be able to download a complete copy of the file 102 using the file portions available from the remaining two content repositories.

In some implementations, the predicted download bandwidths may be monitored, such as by the management system 108, to identify changes in the download speeds. Based on identified download speed changes, the management system 108 may determine updated bandwidth ratios and apply those updated bandwidth ratios accordingly. The application of the updated bandwidth ratios may include transferring file data between content repositories (e.g., to modify the portions of the file 102 that are stored at the respective repositories) and updating the portion mapping file(s) accordingly.

G. Example Implementations of Methods, Systems, and Computer-Readable Media in Accordance with the Present Disclosure

The following paragraphs (M1) through (M12) describe examples of methods that may be implemented in accordance with the present disclosure.

(M1) A method may be performed that involves instructing, by a computing system, a first content repository to store a first part of a file but not a second part of the file, the first content repository being associated with a first internet protocol (IP) address; instructing, by the computing system, a second content repository to store the second part of the file but not the first part of the file, the second content repository being associated with a second IP address that is different than the first IP address; and in response to the computing system receiving a first request for the file from a first client device, instructing, by the computing system, the first client device to retrieve the second part of the file, but not the first part of the file, from the second content repository using the second IP address.

(M2) A method may be performed as described in paragraph (M1), wherein the computing system may comprise at least one server associated with the first IP address, and the method may further involve receiving, by the at least one server and from the first client device, the first request for the file; and sending, from the at least one server to the first client device, the first part of the file.

(M3) A method may be performed as described in paragraph (M1), wherein the computing system may comprise at least one server, and the method may further involve receiving, by the at least one server and from the first client device, the first request for the file; and instructing, by the at least one server, the first client device to retrieve the first part of the file from the first content repository using the first IP address.

(M4) A method may be performed as described in any of paragraphs (M1) through (M3), wherein the first content repository may be located in a first geographic region; and the second content repository may be located in a second geographic region.

(M5) A method may be performed as described in paragraph (M4), wherein the first client device may be located in the first geographic region, and the method may further involve instructing, by the computing system, the first client device to send the first request for the file to the first IP address in response to determining the first client device is located in the first geographic region.

(M6) A method may be performed as described in paragraph (M4) or paragraph (M5), wherein the first client device may be located in the first geographic region, and the method may further involve determining, by the computing system, a first predicted bandwidth between the first content repository and the first client device located in the first geographic region; determining, by the computing system, a second predicted bandwidth between the second content repository and the first client device located in the first geographic region; determining, by the computing system, a ratio of the first predicted bandwidth and the second predicted bandwidth; and determining, by the computing system, a first size of a first portion of the file to be stored at the first content repository based at least in part on the ratio.

(M7) A method may be performed as described in paragraph (M6), and may further involve determining, by the computing system, a second size of a second portion of the file to be stored at the second content repository based at least in part on the ratio.

(M8) A method may be performed as described in paragraph (M4) or paragraph (M5), wherein the first client device may be located in the first geographic region, and the method may further involve determining, by the computing system, a first predicted bandwidth between the first content repository and the first client device located in the first geographic region; determining, by the computing system, a second predicted bandwidth between the second content repository and the first client device located in the first geographic region; determining, by the computing system, a first ratio of the first predicted bandwidth and the second predicted bandwidth; determining, by the computing system, a third predicted bandwidth between the second content repository and a second client device located in the second geographic region; determining, by the computing system, a fourth predicted bandwidth between the first content repository and the second client device located in the second geographic region; determining, by the computing system, a second ratio of the third predicted bandwidth and the fourth predicted bandwidth; and determining, by the computing system, a size of a portion of the file that is to be stored at the first content repository based at least in part on a lesser of the first ratio and the second ratio.

(M9) A method may be performed as described in any of paragraphs (M1) through (M8), and may further involve configuring, by the computing system, the second content repository to send the second part of the file to the first client device in response to the second content repository receiving, from the first client device, a second request for the second part of the file.

(M10) A method may be performed that involves determining, by a computing system, a first predicted bandwidth between a first client device located in a first region and a first content repository located in the first region, the first content repository being associated with a first internet protocol (IP address); determining, by the computing system, a second predicted bandwidth between the first client device located in the first region and a second content repository located in a second region, the second content repository being associated with a second IP address; determining, by the computing system, a first ratio of the first predicted bandwidth and the second predicted bandwidth; determining that a file is to be stored by a combination of the first content repository and the second content repository; determining, by the computing system and based at least in part on the first ratio, a first part of a file that is to be stored by the first content repository and a second part of the file that is to be stored by the second content repository; instructing, by the computing system, the first content repository to store the first part of the file but not the second part of the file; and instructing, by the computing system, the second content repository to store the second part of the file but not the first part of the file.

(M11) A method may be performed as described in paragraph (M10), and may further involve determining, by the computing system, a size of a portion of the file that is to be stored at the first content repository based at least in part on the first ratio.

(M12) A method may be performed as described in paragraph (M10) or paragraph (M11), and may further involve determining, by the computing system, a third predicted bandwidth between the second content repository and a second client device located in a second region; determining, by the computing system, a fourth predicted bandwidth between the first content repository and the second client device located in the second region; determining, by the computing system, a second ratio of the third predicted bandwidth and the fourth predicted bandwidth; and determining, by the computing system, a size of a portion of the file that is to be stored at the first content repository based at least in part on a lesser of the first ratio and the second ratio.

The following paragraphs (S1) through (S12) describe examples of systems and devices that may be implemented in accordance with the present disclosure.

(S1) A computing system may comprise at least one processor, and at least one computer-readable medium encoded with instructions which, when executed by the at least one processor, cause the computing system to instruct a first content repository to store a first part of a file but not a second part of the file, the first content repository being associated with a first internet protocol (IP) address, to instruct a second content repository to store the second part of the file but not the first part of the file, the second content repository being associated with a second IP address that is different than the first IP address, and to instruct, in response to receipt of a first request for the file from a first client device, the first client device to retrieve the second part of the file, but not the first part of the file, from the second content repository using the second IP address.

(S2) A computing system may be configured as described in paragraph (S1), wherein the computing system may comprise at least one server associated with the first IP address, and the at least one computer-readable medium may be further encoded with additional instructions which, when executed by the at least one processor, further cause the computing system to receive, by the at least one server and from the first client device, the first request for the file, and to send, from the at least one server to the first client device, the first part of the file.

(S3) A computing system may be configured as described in paragraph (S1), wherein the computing system may comprise at least one server, and the at least one computer-readable medium may be further encoded with additional instructions which, when executed by the at least one processor, further cause the computing system to receive, by the at least one server and from the first client device, the first request for the file, and to instruct, by the at least one server, the first client device to retrieve the first part of the file from the first content repository using the first IP address.

(S4) A computing system may be configured as described in any of paragraphs (S1) through (S3), wherein the first content repository may be located in a first geographic region; and the second content repository may be located in a second geographic region.

(S5) A computing system may be configured as described in paragraph (S4), wherein the first client device may be located in the first geographic region, and the at least one computer-readable medium may be further encoded with additional instructions which, when executed by the at least one processor, further cause the computing system to instruct the first client device to send the first request for the file to the first IP address in response to determining the first client device is located in the first geographic region.

(S6) A computing system may be configured as described in paragraph (S4) or paragraph (S5), wherein the first client device may be located in the first geographic region, and the at least one computer-readable medium may be further encoded with additional instructions which, when executed by the at least one processor, further cause the computing system to determine a first predicted bandwidth between the first content repository and the first client device located in the first geographic region, to determine a second predicted bandwidth between the second content repository and the first client device located in the first geographic region, to determine a ratio of the first predicted bandwidth and the second predicted bandwidth, and to determine a first size of a first portion of the file to be stored at the first content repository based at least in part on the ratio.

(S7) A computing system may be configured as described in paragraph (S6), wherein the at least one computer-readable medium may be further encoded with additional instructions which, when executed by the at least one processor, further cause the computing system to determine a second size of a second portion of the file to be stored at the second content repository based at least in part on the ratio.

(S8) A computing system may be configured as described in paragraph (S4) or paragraph (S5), wherein the first client device may be located in the first geographic region, and the at least one computer-readable medium may be further encoded with additional instructions which, when executed by the at least one processor, further cause the computing system to determine a first predicted bandwidth between the first content repository and the first client device located in the first geographic region, to determine a second predicted bandwidth between the second content repository and the first client device located in the first geographic region, to determine a first ratio of the first predicted bandwidth and the second predicted bandwidth, to determine a third predicted bandwidth between the second content repository and a second client device located in the second geographic region, to determine a fourth predicted bandwidth between the first content repository and the second client device located in the second geographic region, to determine a second ratio of the third predicted bandwidth and the fourth predicted bandwidth, and to determine a size of a portion of the file that is to be stored at the first content repository based at least in part on a lesser of the first ratio and the second ratio.

(S9) A computing system may be configured as described in any of paragraphs (S1) through (S8), wherein the at least one computer-readable medium may be further encoded with additional instructions which, when executed by the at least one processor, further cause the computing system to configure the second content repository to send the second part of the file to the first client device in response to the second content repository receiving, from the first client device, a second request for the second part of the file.

(S10) A computing system may comprise at least one processor, and at least one computer-readable medium encoded with instructions which, when executed by the at least one processor, cause the computing system to determine a first predicted bandwidth between a first client device located in a first region and a first content repository located in the first region, the first content repository being associated with a first internet protocol (IP address), to determine a second predicted bandwidth between the first client device located in the first region and a second content repository located in a second region, the second content repository being associated with a second IP address, to determine a first ratio of the first predicted bandwidth and the second predicted bandwidth, to determine that a file is to be stored by a combination of the first content repository and the second content repository, to determine, based at least in part on the first ratio, a first part of a file that is to be stored by the first content repository and a second part of the file that is to be stored by the second content repository, to instruct the first content repository to store the first part of the file but not the second part of the file, and to instruct the second content repository to store the second part of the file but not the first part of the file.

(S11) A computing system may be configured as described in paragraph (S10), wherein the at least one computer-readable medium may be further encoded with additional instructions which, when executed by the at least one processor, further cause the computing system to determine a size of a portion of the file that is to be stored at the first content repository based at least in part on the first ratio.

(S12) A computing system may be configured as described in paragraph (S10) or paragraph (S11), wherein the at least one computer-readable medium may be further encoded with additional instructions which, when executed by the at least one processor, further cause the computing system to determine a third predicted bandwidth between the second content repository and a second client device located in a second region, to determine a fourth predicted bandwidth between the first content repository and the second client device located in the second region, to determine a second ratio of the third predicted bandwidth and the fourth predicted bandwidth, and to determine a size of a portion of the file that is to be stored at the first content repository based at least in part on a lesser of the first ratio and the second ratio.

The following paragraphs (CRM1) through (CRM12) describe examples of computer-readable media that may be implemented in accordance with the present disclosure.

(CRM1) At least one non-transitory computer-readable medium may be encoded with instructions which, when executed by at least one processor of a computing system, cause the computing system to instruct a first content repository to store a first part of a file but not a second part of the file, the first content repository being associated with a first internet protocol (IP) address, to instruct a second content repository to store the second part of the file but not the first part of the file, the second content repository being associated with a second IP address that is different than the first IP address, and to instruct, in response to receipt of a first request for the file from a first client device, the first client device to retrieve the second part of the file, but not the first part of the file, from the second content repository using the second IP address.

(CRM2) At least one non-transitory computer-readable medium may be configured as described in paragraph (CRM1), wherein the computing system may comprise at least one server associated with the first IP address, and the at least one computer-readable medium may be further encoded with additional instructions which, when executed by the at least one processor, further cause the computing system to receive, by the at least one server and from the first client device, the first request for the file, and to send, from the at least one server to the first client device, the first part of the file.

(CRM3) At least one non-transitory computer-readable medium may be configured as described in paragraph (CRM1), wherein the computing system may comprise at least one server, and the at least one computer-readable medium may be further encoded with additional instructions which, when executed by the at least one processor, further cause the computing system to receive, by the at least one server and from the first client device, the first request for the file, and to instruct, by the at least one server, the first client device to retrieve the first part of the file from the first content repository using the first IP address.

(CRM4) At least one non-transitory computer-readable medium may be configured as described in any of paragraphs (CRM1) through (CRM3), wherein the first content repository may be located in a first geographic region; and the second content repository may be located in a second geographic region.

(CRM5) At least one non-transitory computer-readable medium may be configured as described in paragraph (CRM4), wherein the first client device may be located in the first geographic region, and the at least one computer-readable medium may be further encoded with additional instructions which, when executed by the at least one processor, further cause the computing system to instruct the first client device to send the first request for the file to the first IP address in response to determining the first client device is located in the first geographic region.

(CRM6) At least one non-transitory computer-readable medium may be configured as described in paragraph (CRM4) or paragraph (CRM5), wherein the first client device may be located in the first geographic region, and the at least one computer-readable medium may be further encoded with additional instructions which, when executed by the at least one processor, further cause the computing system to determine a first predicted bandwidth between the first content repository and the first client device located in the first geographic region, to determine a second predicted bandwidth between the second content repository and the first client device located in the first geographic region, to determine a ratio of the first predicted bandwidth and the second predicted bandwidth, and to determine a first size of a first portion of the file to be stored at the first content repository based at least in part on the ratio.

(CRM7) At least one non-transitory computer-readable medium may be configured as described in paragraph (CRM6), and may be further encoded with additional instructions which, when executed by the at least one processor, further cause the computing system to determine a second size of a second portion of the file to be stored at the second content repository based at least in part on the ratio.

(CRM8) At least one non-transitory computer-readable medium may be configured as described in paragraph (CRM4) or paragraph (CRM5), wherein the first client device may be located in the first geographic region, and the at least one computer-readable medium may be further encoded with additional instructions which, when executed by the at least one processor, further cause the computing system to determine a first predicted bandwidth between the first content repository and the first client device located in the first geographic region, to determine a second predicted bandwidth between the second content repository and the first client device located in the first geographic region, to determine a first ratio of the first predicted bandwidth and the second predicted bandwidth, to determine a third predicted bandwidth between the second content repository and a second client device located in the second geographic region, to determine a fourth predicted bandwidth between the first content repository and the second client device located in the second geographic region, to determine a second ratio of the third predicted bandwidth and the fourth predicted bandwidth, and to determine a size of a portion of the file that is to be stored at the first content repository based at least in part on a lesser of the first ratio and the second ratio.

(CRM9) At least one non-transitory computer-readable medium may be configured as described in any of paragraphs (CRM1) through (CRM8), and may be further encoded with additional instructions which, when executed by the at least one processor, further cause the computing system to configure the second content repository to send the second part of the file to the first client device in response to the second content repository receiving, from the first client device, a second request for the second part of the file.

(CRM10) At least one non-transitory computer-readable medium may be encoded with instructions which, when executed by at least one processor of a computing system, cause the computing system to determine a first predicted bandwidth between a first client device located in a first region and a first content repository located in the first region, the first content repository being associated with a first internet protocol (IP address), to determine a second predicted bandwidth between the first client device located in the first region and a second content repository located in a second region, the second content repository being associated with a second IP address, to determine a first ratio of the first predicted bandwidth and the second predicted bandwidth, to determine that a file is to be stored by a combination of the first content repository and the second content repository, to determine, based at least in part on the first ratio, a first part of a file that is to be stored by the first content repository and a second part of the file that is to be stored by the second content repository, to instruct the first content repository to store the first part of the file but not the second part of the file, and to instruct the second content repository to store the second part of the file but not the first part of the file.

(CRM11) At least one non-transitory computer-readable medium may be configured as described in paragraph (CRM10), and may be further encoded with additional instructions which, when executed by the at least one processor, further cause the computing system to determine a size of a portion of the file that is to be stored at the first content repository based at least in part on the first ratio.

(CRM12) At least one non-transitory computer-readable medium may be configured as described in paragraph (CRM10) or paragraph (CRM11), and may be further encoded with additional instructions which, when executed by the at least one processor, further cause the computing system to determine a third predicted bandwidth between the second content repository and a second client device located in a second region, to determine a fourth predicted bandwidth between the first content repository and the second client device located in the second region, to determine a second ratio of the third predicted bandwidth and the fourth predicted bandwidth, and to determine a size of a portion of the file that is to be stored at the first content repository based at least in part on a lesser of the first ratio and the second ratio.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
instructing, by a computing system, a first content repository to store a first part of a file but not a second part of the file, the first content repository being associated with a first internet protocol (IP) address;
instructing, by the computing system, a second content repository to store the second part of the file but not the first part of the file, the second content repository being associated with a second IP address that is different than the first IP address; and
in response to the computing system receiving a first request for the file from a first client device, instructing, by the computing system, the first client device to retrieve the second part of the file, but not the first part of the file, from the second content repository using the second IP address.

2. The method of claim 1, wherein the computing system comprises at least one server associated with the first IP address, and the method further comprises:
receiving, by the at least one server and from the first client device, the first request for the file; and
sending, from the at least one server to the first client device, the first part of the file.

3. The method of claim 1, wherein the computing system comprises at least one server, and the method further comprises:
receiving, by the at least one server and from the first client device, the first request for the file; and
instructing, by the at least one server, the first client device to retrieve the first part of the file from the first content repository using the first IP address.

4. The method of claim 1, wherein:
the first content repository is located in a first geographic region; and
the second content repository is located in a second geographic region.

5. The method of claim 4, wherein the first client device is located in the first geographic region, and the method further comprises:
instructing, by the computing system, the first client device to send the first request for the file to the first IP address in response to determining the first client device is located in the first geographic region.

6. The method of claim 4, wherein the first client device is located in the first geographic region, and the method further comprises:
determining, by the computing system, a first predicted bandwidth between the first content repository and the first client device located in the first geographic region;
determining, by the computing system, a second predicted bandwidth between the second content repository and the first client device located in the first geographic region;
determining, by the computing system, a ratio of the first predicted bandwidth and the second predicted bandwidth; and
determining, by the computing system, a first size of a first portion of the file to be stored at the first content repository based at least in part on the ratio.

7. The method of claim 6, further comprising:
determining, by the computing system, a second size of a second portion of the file to be stored at the second content repository based at least in part on the ratio.

8. The method of claim 4, wherein the first client device is located in the first geographic region, and the method further comprises:
determining, by the computing system, a first predicted bandwidth between the first content repository and the first client device located in the first geographic region;
determining, by the computing system, a second predicted bandwidth between the second content repository and the first client device located in the first geographic region;
determining, by the computing system, a first ratio of the first predicted bandwidth and the second predicted bandwidth;
determining, by the computing system, a third predicted bandwidth between the second content repository and a second client device located in the second geographic region;
determining, by the computing system, a fourth predicted bandwidth between the first content repository and the second client device located in the second geographic region;
determining, by the computing system, a second ratio of the third predicted bandwidth and the fourth predicted bandwidth; and
determining, by the computing system, a size of a portion of the file that is to be stored at the first content repository based at least in part on a lesser of the first ratio and the second ratio.

9. The method of claim 1, further comprising:
configuring, by the computing system, the second content repository to send the second part of the file to the first client device in response to the second content repository receiving, from the first client device, a second request for the second part of the file.

10. A method, comprising:
determining, by a computing system, a first predicted bandwidth between a first client device located in a first region and a first content repository located in the first region, the first content repository being associated with a first internet protocol (IP address);
determining, by the computing system, a second predicted bandwidth between the first client device located in the first region and a second content repository located in a second region, the second content repository being associated with a second IP address;
determining, by the computing system, a first ratio of the first predicted bandwidth and the second predicted bandwidth;
determining that a file is to be stored by a combination of the first content repository and the second content repository;
determining, by the computing system and based at least in part on the first ratio, a first part of a file that is to be stored by the first content repository and a second part of the file that is to be stored by the second content repository;
instructing, by the computing system, the first content repository to store the first part of the file but not the second part of the file; and
instructing, by the computing system, the second content repository to store the second part of the file but not the first part of the file.

11. The method of claim 10, further comprising:
determining, by the computing system, a size of a portion of the file that is to be stored at the first content repository based at least in part on the first ratio.

12. The method of claim 10, further comprising:
determining, by the computing system, a third predicted bandwidth between the second content repository and a second client device located in a second region;
determining, by the computing system, a fourth predicted bandwidth between the first content repository and the second client device located in the second region;
determining, by the computing system, a second ratio of the third predicted bandwidth and the fourth predicted bandwidth; and
determining, by the computing system, a size of a portion of the file that is to be stored at the first content repository based at least in part on a lesser of the first ratio and the second ratio.

13. A computing system, comprising:
at least one processor; and
at least one computer-readable medium encoded with instructions which, when executed by the at least one processor, cause the computing system to:
instruct a first content repository to store a first part of a file but not a second part of the file, the first content repository being associated with a first internet protocol (IP) address,
instruct a second content repository to store the second part of the file but not the first part of the file, the second content repository being associated with a second IP address that is different than the first IP address, and
instruct, in response to receipt of a first request for the file from a first client device, the first client device to retrieve the second part of the file, but not the first part of the file, from the second content repository using the second IP address.

14. The computing system of claim 13, wherein the computing system comprises at least one server associated with the first IP address, and the at least one computer-readable medium is further encoded with additional instructions which, when executed by the at least one processor, further cause the computing system to:
receive, by the at least one server and from the first client device, the first request for the file; and
send, from the at least one server to the first client device, the first part of the file.

15. The computing system of claim 13, wherein the computing system comprises at least one server, and the at least one computer-readable medium is further encoded with additional instructions which, when executed by the at least one processor, further cause the computing system to:
receive, by the at least one server and from the first client device, the first request for the file; and
instruct, by the at least one server, the first client device to retrieve the first part of the file from the first content repository using the first IP address.

16. The computing system of claim 13, wherein the at least one computer-readable medium is further encoded with additional instructions which, when executed by the at least one processor, further cause the computing system to:
instruct the first client device to send the first request for the file to the first IP address in response to determining the first client device is located in a first geographic region.

17. The computing system of claim 13, wherein the at least one computer-readable medium is further encoded with additional instructions which, when executed by the at least one processor, further cause the computing system to:
determine a first predicted bandwidth between the first content repository located in a first geographic region and the first client device located in the first geographic region;
determine a second predicted bandwidth between the second content repository located in a second geographic region and the first client device located in the first geographic region;
determine a ratio of the first predicted bandwidth and the second predicted bandwidth; and
determine a first size of a first portion of the file to be stored at the first content repository based at least in part on the ratio.

18. The computing system of claim 17, wherein the at least one computer-readable medium is further encoded with additional instructions which, when executed by the at least one processor, further cause the computing system to:
determine a second size of a second portion of the file to be stored at the second content repository based at least in part on the ratio.

19. The computing system of claim 13, wherein the at least one computer-readable medium is further encoded with additional instructions which, when executed by the at least one processor, further cause the computing system to:
determine a first predicted bandwidth between the first content repository located in a first geographic region and the first client device located in the first geographic region;
determine a second predicted bandwidth between the second content repository located in a second geographic region and the first client device located in the first geographic region;
determine a first ratio of the first predicted bandwidth and the second predicted bandwidth;
determine a third predicted bandwidth between the second content repository and a second client device located in the second geographic region;
determine a fourth predicted bandwidth between the first content repository and the second client device located in the second geographic region;
determine a second ratio of the third predicted bandwidth and the fourth predicted bandwidth; and
determine a size of a portion of the file that is to be stored at the first content repository based at least in part on a lesser of the first ratio and the second ratio.

20. The computing system of claim 13, wherein the at least one computer-readable medium is further encoded with additional instructions which, when executed by the at least one processor, further cause the computing system to:
configure the second content repository to send the second part of the file to the first client device in response to the second content repository receiving, from the first client device, a second request for the second part of the file.
